(19) United States
(12) Patent Application Publication
(10) Pub. No.: US 2025/0100343 A1
(43) Pub. Date: Mar. 27, 2025

(54) METHOD FOR REMOTELY TRACKING AND MONITORING ENERGY OF A TRAILER ALONG A DRIVE ROUTE

(71) Applicant: Range Energy Inc., Mountain View, CA (US)

(72) Inventors: Kyle Foley, Half Moon Bay, CA (US); Bryan Booth, San Mateo, CA (US); Collin MacGregor, Redwood City, CA (US); Ryan Flatland, San Carlos, CA (US); Brinton Mooberry, San Mateo, CA (US); Theodore DeGuzman, Palo Alto, CA (US); Ali Javidan, Sunnyvale, CA (US)

(21) Appl. No.: 18/920,773

(22) Filed: Oct. 18, 2024

Related U.S. Application Data
(63) Continuation-in-part of application No. 18/381,583, filed on Oct. 18, 2023.
Application No. 18/381,583 is a continuation-in-part of application No. 18/238,405, filed on Aug. 25, 2023.
Application No. 18/238,405 is a continuation-in-part of application No. 18/238,408, filed on Aug. 25, 2023, now Pat. No. 11,965,795.
Application No. 18/238,408 is a continuation-in-part of application No. 18/238,415, filed on Aug. 25, 2023.
(60) Provisional application No. 63/603,548, filed on Nov. 28, 2023.
(60) Provisional application No. 63/603,825, filed on Nov. 29, 2023.
(60) Provisional application No. 63/417,212, filed on Oct. 18, 2022.
(60) Provisional application No. 63/401,030, filed on Aug. 25, 2022.
(60) Provisional application No. 63/420,469, filed on Oct. 28, 2022.
(60) Provisional application No. 63/431,273, filed on Dec. 8, 2022.
(60) Provisional application No. 63/417,212, filed on Oct. 18, 2022.
(60) Provisional application No. 63/401,030, filed on Aug. 25, 2022.
(60) Provisional application No. 63/420,469, filed on Oct. 28, 2022.
(60) Provisional application No. 63/431,273, filed on Dec. 8, 2022.
(60) Provisional application No. 63/417,212, filed on Oct. 18, 2022.
(60) Provisional application No. 63/401,030, filed on Aug. 25, 2022.
(60) Provisional application No. 63/420,469, filed on Oct. 28, 2022.
(60) Provisional application No. 63/431,273, filed on Dec. 8, 2022.

(51) Int. Cl. B60H 1/00; B60L 1/00; B60L 7/10; B60L 15/20; B60P 3/20; B60R 16/033; G07C 5/04

(52) U.S. Cl. CPC B60H 1/0073; B60L 1/003; B60L 7/10; B60L 15/2045; B60R 16/033; B60L 2200/28; B60P 3/20; G07C 5/04

(57) ABSTRACT

One variation of a method includes: accessing a drive route for a trailer between a current location and a destination location; accessing a threshold temperature for an interior of the trailer; predicting a time duration between arrival of the trailer at the destination location and unloading a set of goods contained in the interior; estimating a quantity of electrical energy to maintain temperatures of the interior within the target temperature range for the time duration; calculating a state of charge of a battery assembly of the trailer to supply the quantity of electrical energy to a refrigeration system to modulate temperatures of the interior; and during traversal of the drive route, selectively outputting torque to and regeneratively braking the driven axle to increase fuel efficiency of the tow vehicle and to achieve the state of charge of the battery assembly upon arrival of the trailer at the destination location.

### CROSS-REFERENCE TO RELATED APPLICATIONS

This application claims the benefit of U.S. Provisional Application No. 63/603,548, filed on 28 Nov. 2023, and 63/603,825, filed on 29 Nov. 2023.

This application is a continuation-in-part application of U.S. patent application Ser. No. 18/381,583, filed on 18 Oct. 2023, which is a continuation-in-part application of U.S. patent application Ser. No. 18/238,405, filed on 25 Aug. 2023, Ser. No. 18/238,408, filed on 25 Aug. 2023, and Ser. No. 18/238,415, filed on 25 Aug. 2023, each of which claim the benefit of U.S. Provisional Application No. 63/417,212, filed on 18 Oct. 2022, 63/401,030, filed on 25 Aug. 2022, 63/420,469, filed on 28 Oct. 2022, and 63/431,273, filed on 8 Dec. 2022, each of which is incorporated in its entirety by this reference.

### TECHNICAL FIELD

This invention relates generally to the field of overland trucking and more specifically to a new and useful method for remotely tracking and monitoring energy of a trailer along a drive route in the field of overland trucking.

### BRIEF DESCRIPTION OF THE FIGURES

FIGS. 1A and 1B are schematic representations of a system;

FIGS. 2A, 2B, and 2C are schematic representations of one variation of the system;

FIGS. 3A and 3B are schematic representations of one variation of the system;

FIG. 4 is a schematic representation of one variation of the system;

FIGS. 5A, 5B, 5C, and 5D are schematic representations of one variation of the system;

FIG. 6 is a block diagram of one variation of the system;

FIGS. 7A and 7B are flowchart representations of a method;

FIG. 8 is a flowchart representation of one variation of the method;

FIG. 9 is a flowchart representation of one variation of the method; and

FIG. 10 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

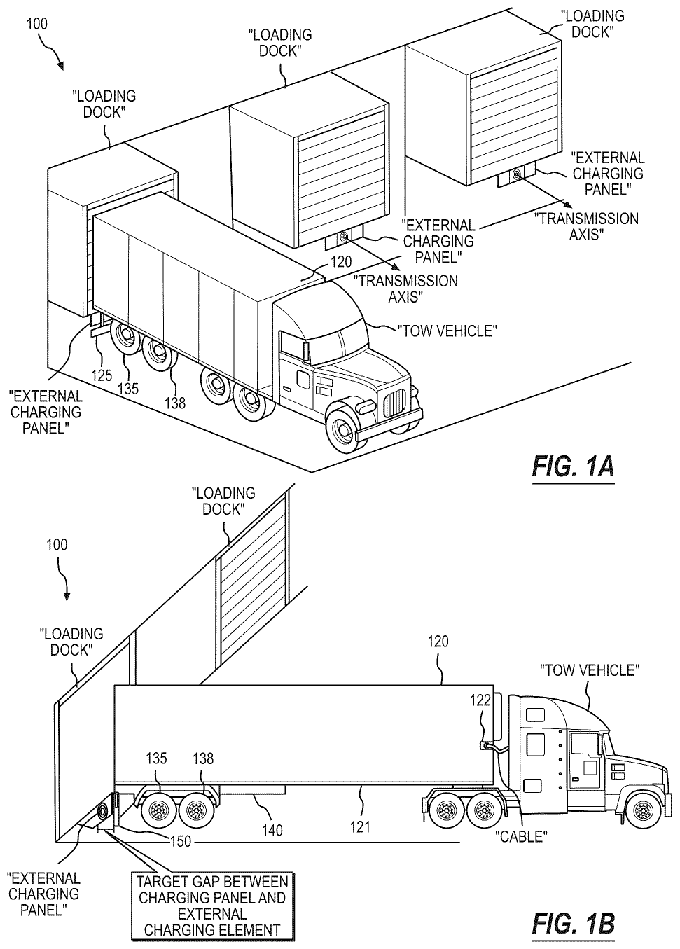

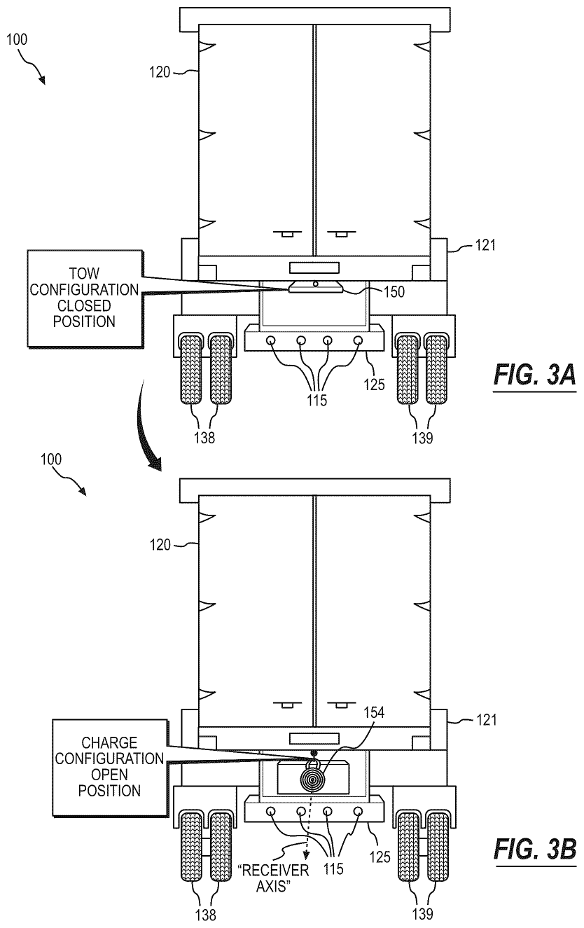

As shown in FIGS. 1A, 1B, 3A, and 3B, a system 100 for power distribution of a trailer 120 includes: a trailer chassis 121; a driven axle 137; a motor 131; a battery assembly 140; a charging panel 150; a panel actuator 156; and a controller 160. The trailer chassis 121 includes a vehicle coupler 110 arranged on a first end 128 of the trailer chassis 121 and configured to couple to a tow vehicle. The driven axle 137 is suspended from the trailer chassis 121 and the motor 131 is coupled to the driven axle 137. The battery assembly 140 is: coupled to the trailer chassis 121; is arranged on a second end 129 of the trailer chassis 121 opposite the first end 128; configured to supply electrical energy to the motor 131 to drive the driven axle 137; and configured to source electrical energy from the motor 131 to slow motion of the driven axle 137. The charging panel 150 is coupled to the trailer chassis 121, arranged on the second end 129 of the trailer 120 adjacent the battery assembly 140, and configured to inductively couple to an external charging element. The panel actuator 156 is configured to: drive the charging panel 150 downwardly from the trailer chassis 121 to convert energy from the external charging element into electrical energy; and retract the charging panel 150 upwardly to decouple the charging panel 150 from the external charging element.

The controller 160 is configured to, at a first time: detect the trailer chassis 121 coupled to the tow vehicle via the vehicle coupler 110; detect a first state of charge of a battery pack of the tow vehicle; detect a second state of charge of the battery assembly 140 of the trailer 120; and, in response to the second state of charge of the battery assembly 140 of the trailer 120 exceeding the first state of charge of the battery pack of the tow vehicle, direct a first portion of electrical energy, converted by the charging panel 150, to the battery pack of the tow vehicle and direct a second portion of electrical energy, less than the first portion, to the battery assembly 140 of the trailer 120.

In one variation, the system 100 includes: a trailer chassis 121; a driven axle 137; a motor 131; a battery assembly 140; a charging panel 150; a panel actuator 156; and a controller 160. The trailer chassis 121 includes a vehicle coupler 110 arranged on a first end 128 of the trailer chassis 121 and configured to couple to a tow vehicle. The driven axle 137 is suspended from the trailer chassis 121 and the motor 131 is coupled to the driven axle 137. The battery assembly 140: includes a set of latches configured to transiently engage a subset of engagement features, in the first array of engagement features and in the second array of engagement features, to retain the battery assembly 140 below the trailer chassis 121; is configured to supply electrical energy to the motor 131 to drive the driven axle 137; and is configured to source electrical energy from the motor 131 to slow motion of the driven axle 137.

In this variation, the charging panel 150: is coupled to the trailer chassis 121; is arranged on a second end 129 of the trailer chassis 121 opposite the first end 128; is operable in a charge configuration, the charging panel 150 facing and inductively coupled to an external charging element to store energy from the external charging element and convert energy into electrical energy in the charge configuration; and is operable in a tow configuration, the charging panel 150 decoupled from the external charging element in the tow configuration. The panel actuator 156 is configured to actuate the charging panel 150. The controller 160 is configured to trigger the panel actuator 156 to maneuver the charging panel 150 between the charge configuration and the tow configuration and distribute electrical energy to a battery pack of the tow vehicle and the battery assembly 140 of the trailer 120 according to a charge order.

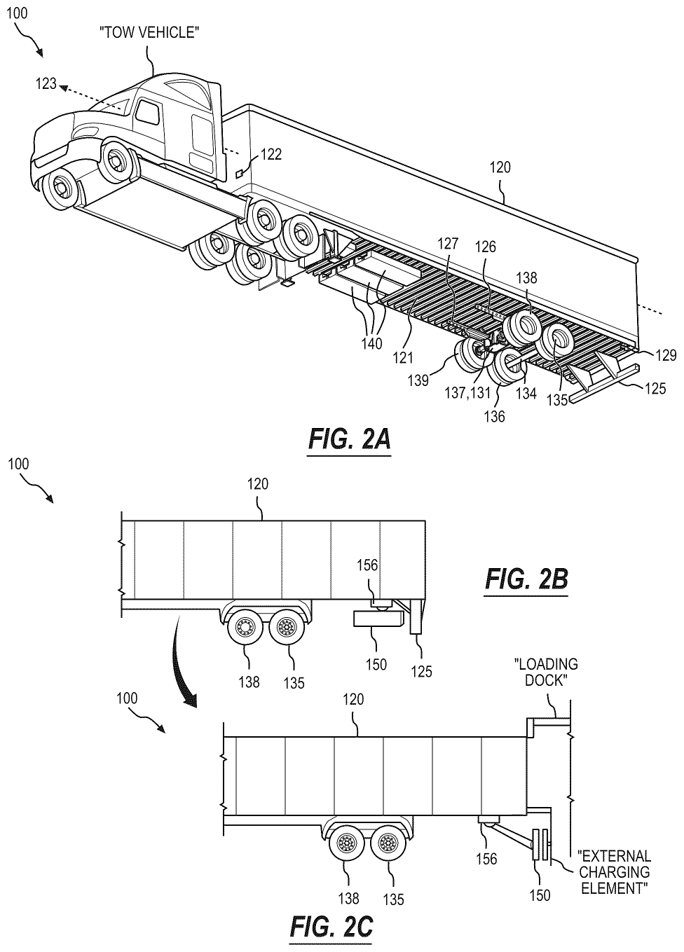

In another variation, shown in FIGS. 2A, 2B, and 2C, the system 100 includes: a trailer chassis 121; a driven axle 137; a motor 131; a battery assembly 140; a charging panel 150; and a panel actuator 156. The trailer chassis 121 includes a vehicle coupler 110 arranged on a first end 128 of the trailer chassis 121 and configured to couple to a tow vehicle. The driven axle 137 is suspended from the trailer chassis 121 and the motor 131 is coupled to the driven axle 137. The battery assembly 140 is coupled to the trailer chassis 121, arranged on a second end 129 of the trailer chassis 121 opposite the first end 128, configured to supply electrical energy to the motor 131 to drive the driven axle 137, and configured to source electrical energy from the motor 131 to slow motion of the driven axle 137. The charging panel 150: is coupled to the trailer chassis 121; is arranged on a second end 129 of the trailer chassis 121 opposite the first end 128; and is configured to inductively couple to an external charging element. The panel actuator 156 is configured to downwardly pivot the charging panel 150 from the trailer chassis 121 to an open position to form a target gap between the external charging element and the charging panel 150 and to upwardly pivot the charging panel 150 to a closed position to decouple the charging panel 150 from the external charging element.

### 2. Applications

Generally, the system 100 defines an electric trailer 120 that includes: a trailer chassis 121; a set of rails 126,127; a vehicle coupler such as a kingpin 110; a trailer coupler; a driven axle 137; a motor 131; a set of sensors 115; a battery assembly 140; a charging panel 150; a panel actuator 156; and a controller 160.

More specifically, the set of sensors 115 can include force sensors (e.g., a strain gauge, an inertial measurement unit, a load cell), optical sensors (e.g., a one-dimensional depth sensor, a LIDAR sensor, an RGB camera), inertial sensors (e.g., an inertial measurement unit, an accelerometer, a gyroscope); and/or proximity sensors (e.g., an electromagnetic field sensor, a Hall effect sensor, a conductive sensor, an inductive sensor) coupled to the trailer chassis 121, the kingpin 110, or a rear impact guard 125. The set of sensors 115 can transmit signals to the controller 160 to detect a condition of the trailer 120. The system 100 further includes: a battery assembly 140 configured to transiently install on the trailer 120 over a range of longitudinal positions and integrated directly with the trailer chassis 121 in order to receive electrical energy and to supply electrical energy to the motor 131; and a charging panel 150 coupled to the trailer chassis 121 and arranged on the second end 129 of the trailer chassis 121 adjacent the battery assembly 140. The charging panel 150 is configured to inductively and/or conductively couple to an external charging element of a loading dock to receive energy from the external charging element, convert this energy into electrical energy, and route electrical energy to the controller 160. The system 100 also includes an electromechanical, pneumatic, or hydraulic panel actuator 156 coupled to and arranged on the second end of the trailer chassis 121 and configured to actuate the charging panel 150.

Additionally, the system 100 is operable in a set of modes, including a charge mode and a tow mode. In particular, the controller 160 can: access a signal from the array of proximity sensors 115; detect presence of the external charging element within the threshold distance of the rear impact guard 125; and, in response to detecting presence of the external charging element within the threshold distance of the rear impact guard 125, enter the charge mode and trigger the panel actuator 156 to downwardly pivot the charging panel 150 from the trailer chassis 121 to an open position to inductively couple to the external charging element. In the charge mode, the controller 160 can: detect a state of charge of the battery assembly 140 of the trailer 120 and/or an energy storage system of an additional electric tow vehicle or secondary trailer, or any other battery powered device coupled to the trailer 120; and selectively direct portions of electrical energy, converted by the charging panel 150, to the battery assembly 140 of the trailer 120, to a battery pack of a tow vehicle coupled to the trailer 120, to a battery module or electrical system of the secondary trailer, and to any other battery powered device based on these state of charges.

At the end of charge mode, the controller 160 can interface with the integrated controller of the kingpin 110 to detect forces applied to the kingpin 110 by the hitch of the tow vehicle, trigger the panel actuator 156 to upwardly pivot the charging panel 150 to the closed position, and enter a tow mode. In tow mode, the controller 160 can: detect conditions of the trailer 120 such as including: a direction of motion of the trailer 120; a tractor-trailer angle (e.g., a steering angle); a speed of the trailer 120; an incline angle of the trailer 120 (e.g., a grade of a ground surface); a location of the trailer 120; forces applied to the kingpin 110 (e.g., lateral forces, longitudinal forces, total forces); and a state of charge of the battery assembly 140 of the trailer 120. The controller 160 can then: calculate a target preload force proportional to and/or inversely proportional to the condition of the trailer 120; and trigger the motor 131 to increase torque output and/or reduce torque output in the direction of motion of the trailer 120 to decrease a difference between the target preload force and a total force applied to the kingpin 110 to control the trailer 120 in conjunction with the tow vehicle.

### 2.1 Charge Mode

Once the charging panel 150 occupies the open position in the charge configuration, the controller 160 can: detect a state of charge of the battery assembly 140 of the trailer 120 and/or additional tow vehicles (e.g., electric tractors, hybrid tractors, hydrogen fuel cell tractors) or secondary trailers (e.g., dry van trailers, refrigerated trailers) coupled to the trailer 120; selectively direct portions of electrical energy to the battery assembly 140 of the trailer 120, to a battery module of a tow vehicle coupled to the trailer 120, and/or to secondary trailers coupled to the trailer 120 based on these state of charges.

In one example, in the charge mode, the controller 160: detects a state of charge of the battery assembly 140 of the trailer 120; and, in response to the state of charge of the battery assembly falling below a threshold state of charge, selectively directs a portion of electrical energy to the battery assembly 140 and thus, prioritizes charging the battery assembly 140.

In another example, in the charge mode, the controller 160: detects a hitch of a tow vehicle coupled to the trailer 120 via the kingpin 110; detects a state of charge of the battery assembly 140 of the trailer 120; detects a state of charge of an energy storage system—such as a battery pack, a battery module, or a battery assembly—of the tow vehicle; and accesses a charge order defining a set of charging rules or instructions. The controller 160 then identifies a charging rule or instruction corresponding to each state of charge and directs a corresponding portion of electrical energy, defined in the charge order, to the battery assembly 140 of the trailer 120 and to the energy storage system of the tow vehicle. Thus, the controller 160 prioritizes charging the energy storage system of the tow vehicle, which may be connected to the trailer 120 for a short time duration and manages the state of charge of the battery assembly of the trailer 120.

In yet another example, in the charge mode, the controller 160: detects the trailer 120 coupled to the hitch of the tow vehicle via the kingpin 110 and coupled to a secondary trailer via the trailer coupler; detects a state of charge of the battery assembly 140 of the trailer 120; and accesses a charge order defining a set of charging rules or instructions. The controller 160 then identifies a charging rule or instruction corresponding to each state of charge and directs a corresponding portion of electrical energy, defined in the charge order, from the charging panel 150 to the battery assembly 140 of the trailer 120 and to a secondary battery assembly of the secondary trailer and/or additional electrical systems coupled to the secondary trailer, such as a refrigeration system, in order to power the refrigeration system of the secondary trailer. Thus, the controller 160 prioritizes charging the energy storage system of the tow vehicle and manages the state of charge of the battery assembly of the trailer 120 in preparation for a subsequent trip and to supply power to the refrigeration system of the secondary trailer.

### 2.2 Tow Mode

The controller 160 can then operate the charging panel 150 in a tow configuration by triggering the charging panel 150 to pivot upwardly from the open position to a closed position facing the trailer chassis 121 and enter a tow mode.

Once the charging panel 150 occupies the closed position in the tow configuration, the controller 160 can detect conditions of the trailer 120 such as: a direction of motion of the trailer 120 (e.g., a forward direction, a reverse direction); a tractor-trailer angle (e.g., a steering angle); a speed of the trailer 120; an incline angle of the trailer 120 (e.g., a grade of a ground surface); a location of the trailer 120; forces applied to the kingpin 110 (e.g., lateral forces, longitudinal forces, total forces); and a state of charge of the battery assembly 140 (e.g., a status, a level, a percentage). The controller 160 can then: calculate a target preload force proportional to and/or inversely proportional to the condition of the trailer 120; and trigger the motor 131 to increase torque output and/or reduce torque output in the direction of motion of the trailer 120 to decrease a difference between the target preload force and a total force applied to the kingpin 110 to control the trailer 120 in conjunction with the tow vehicle.

### 2.2 Power Distribution

Therefore, the system 100 can autonomously transition between the charge mode and the tow mode responsive to local conditions detected by the system 100. Additionally, while the trailer 120 is docked and the charging panel 150 is conductively coupled to an external charging element of a loading dock, the system 100 can autonomously manage power distribution between the external charging element, the battery assembly 140 of the trailer 120, an energy storage system of a tow vehicle, a battery powered device, and/or a refrigeration system of a secondary refrigerated trailer coupled to the trailer 120.

Alternatively, while the trailer 120 is docked and the charging panel 150 is inductively coupled to an external charging element of a loading dock, the system 100 can autonomously manage power distribution between the external charging element, the battery assembly 140 of the trailer 120, an energy storage system of a tow vehicle, a battery powered device, and/or a refrigeration system of a secondary refrigerated trailer coupled to the trailer 120 without necessitating insertion or a mechanical connection of a power cable to a power port on the tow vehicle or the trailer 120.

### 3. Trailer

Generally, the trailer 120 includes: a trailer chassis 121; a set of rails 126,127; a vehicle coupler such as a kingpin no; a trailer coupler; a driven axle 137; a motor 131; and a set of sensors. The left rail 126 and the right rail 127 are coupled to the trailer chassis 121 and run along a longitudinal axis 123 of the trailer 120, extending parallel to and laterally offset from a longitudinal centerline, to form a channel below the trailer chassis 121 of the trailer 120.

In one implementation, the trailer 120 includes: a trailer chassis 121; a left rail 126 coupled to the trailer chassis 121, extending parallel to and laterally offset from a longitudinal centerline of the trailer 120, and defining a first array of engagement features distributed along the left rail and longitudinally offset by a pitch distance; and a right rail 127 coupled to the trailer chassis 121, extending parallel to and laterally offset from the longitudinal centerline of the trailer 120 opposite the left rail, and defining a second array of engagement features distributed along the right rail and longitudinally offset by the pitch distance. In this implementation, the set of rails 126, 127 extends along a length of the trailer 120 and defines a channel below trailer chassis 121. Alternatively, the set of rails 126, 127 extends along a portion of the length of the trailer 120 and defines a channel below the trailer chassis 121 of the trailer 120.

Furthermore, the set of engagement features 124 can include a bore, a slot, an aperture, or an indentation distributed along each rail 126, 127 and configured to engage and retain a corresponding latch of a bogie 130 and/or a battery assembly 140, as further described below. However, each rail 126, 127 can include any other type of engagement feature configured to engage and retain a set of latches 133 of a bogie 130 and/or a battery assembly 140.

### 3.1 Trailer Chassis+Vehicle Coupler

In one variation, the trailer chassis 121 can include a vehicle coupler 110 to couple the trailer 120 to a tow vehicle—such as a tractor unit, a hybrid tractor, an electric tractor, a hydrogen fuel cell tractor, and/or an internal combustion engine tractor—in order to form a tractor-trailer 120 (e.g., a semi-truck, a semi, an 18-wheeler). For example, the trailer chassis 121 can include a kingpin 110 arranged on a proximal end 128 of the trailer chassis 121 and configured to interface with a fifth wheel of a tractor, as further described below.

Additionally, the vehicle coupler 110 is configured to couple to a secondary trailer—such as a dry van trailer or a refrigerated trailer—in order to form a longer combination vehicle (e.g., a tandem, a road-train, double trailers, triple trailers).

In one example, a dry van trailer includes a trailer chassis 121 and a vehicle coupler 110. The vehicle coupler 110 is arranged on the first end of the trailer chassis 121 and interfaces with a trailer coupler of a second dry van trailer to form a set of dry van trailers coupled in tandem with a tractor.

In another example, a dry van trailer includes a trailer chassis 121 and a vehicle coupler 110. The vehicle coupler 110 is arranged on the first end of the trailer chassis 121 and interfaces with a trailer coupler of a second refrigerated trailer to form a longer combination vehicle with a tractor.

The trailer chassis 121 supports the driven axle 137. The trailer chassis 121 can be manufactured from a metal such as stainless steel or aluminum alloy (e.g., 6061 or 7075). Additionally, the trailer chassis 121 can define a frame mounted to the floor of the trailer 120, such as by welding the trailer chassis 121 to the floor or bolting the trailer chassis 121 to the floor via a set of fasteners. However, the trailer chassis 121 can be manufactured in any other way and transiently installed on the trailer 120 in any other way.

### 3.1.1 Kingpin

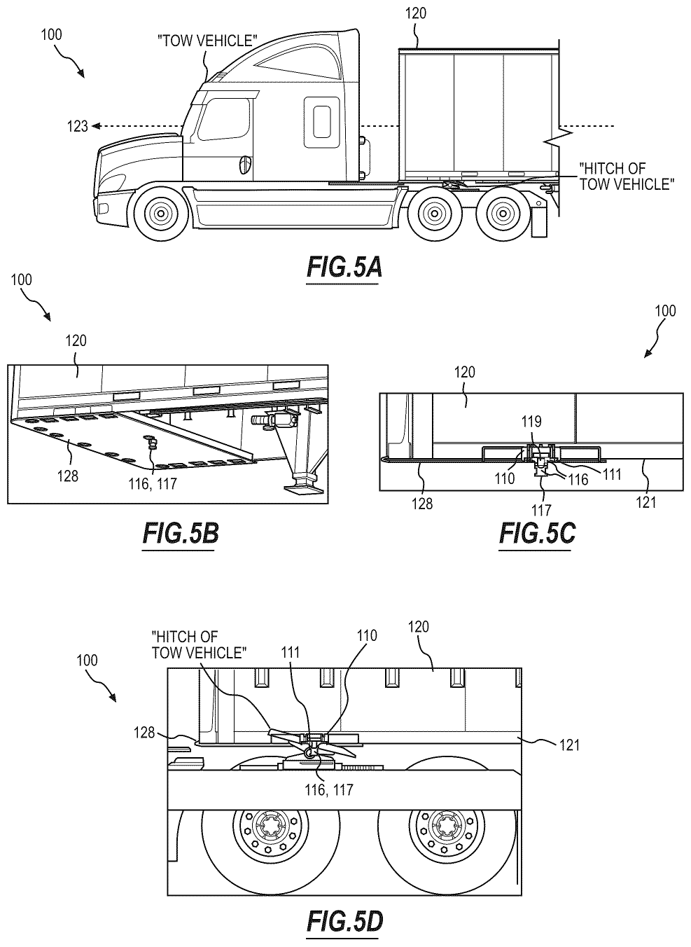

The trailer 120 can further include a kingpin 110 arranged on a proximal end 128 of the trailer 120 opposite the bogie 130 and is configured to interface with a hitch (e.g., a fifth wheel) of a tow vehicle. The kingpin 110 further includes a set of sensors configured to output a signal representing forces applied to the kingpin no by the hitch, as shown in FIGS. 5A, 5B, 5C, and 5D.

In one implementation, the kingpin no includes: a head 117; a shank 116; a base in; a set of fasteners; a geolocation module; a wireless communications module; and a suite of sensors 119 including force sensors (e.g., a strain gauge, an IMU, a load cell), optical sensors (e.g., a one-dimensional depth sensor, a LIDAR sensor, an RGB camera), and/or inertial sensors (e.g., an IMU, an accelerometer, a gyroscope). The kingpin no is further characterized by a unitary steel alloy structure.

In one variation, the kingpin no is coupled to a floor of a trailer 120 and is configured to transfer vertical loads from the trailer 120 into a hitch of a tow vehicle. In this variation, the set of sensors 119 are configured to: output signals representing forces applied to the kingpin no (e.g., via the force sensors); output signals representing inertial conditions of the trailer 120 (e.g., via the inertial sensors); output signals representing a location of the trailer 120 (e.g., via the geolocation module); and transmit these force data, inertial conditions data, weight distribution data, and/or geolocation data to the integrated controller via the communications module.

In another variation, the base in of the kingpin 110 defines a set of through-bores 114 arranged radially about the shank 116 and configured to receive a set of fasteners to couple the kingpin 110 to a floor of the trailer 120 and thus, fasten (e.g., mount, bolt-in) the kingpin 110 to the trailer 120. In this variation, the shank 116 of the kingpin 110 defines a first sensor receptacle extending parallel to a lateral axis of the trailer 120; and defines a second sensor receptacle extending parallel to a longitudinal axis 123 of the trailer 120. Further, a first strain gauge is arranged in the first sensor receptacle and is configured to output a signal representing shear forces in the kingpin 110 parallel to the lateral axis and a second strain gauge is arranged in the second sensor receptacle and configured to output the second signal representing shear forces in the kingpin 110 parallel to the longitudinal axis 123.

In yet another variation, the kingpin 110 can include a set of force sensors 119. In this variation, the kingpin 110 can include: a first sensor 119 configured to output signals representing lateral forces (e.g., loads) applied to the kingpin no; and a second sensor 119 configured to output signals corresponding to longitudinal forces (e.g., loads), parallel to a longitudinal axis 123 of the trailer 120, applied to the kingpin 110. Each sensor can then transmit these force data to the integrated controller.

The kingpin 110 can further include an integrated controller configured to interface (e.g., via wireless communication, via wired communication) with the controller 160 in order to: calculate a direction and a magnitude of each force applied to the kingpin 110; identify a coupling and/or a decoupling event between a hitch (e.g., a fifth wheel) of a tow vehicle (e.g., a tractor-trailer 120) and the kingpin no based on these forces; calculate a target preload force as a function of a condition of the trailer 120 (e.g., a speed, an incline angle, a tractor-trailer angle, a location, a state of charge of a battery assembly 140, a weight distribution) in a tow mode; and, trigger the motor 131 to selectively reduce torque output and/or increase torque output to decrease a difference between each force and the target preload force in the tow mode.

### 3.1.2 Bogie

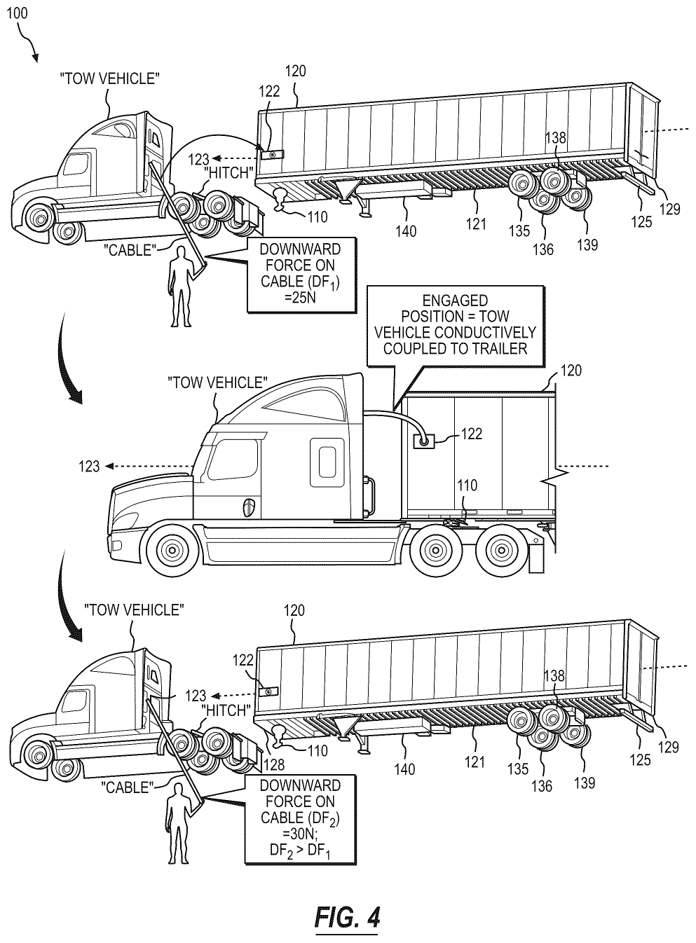

In one variation, the system 100 further includes a bogie 130. Further, the bogie includes: a chassis 132; a set of latches 133; a driven axle 137 suspended from the chassis 132; and a motor 131 coupled to the driven axle 137, as shown in FIG. 4.

In one implementation, the bogie 130 includes: a chassis 132 configured to transiently install on a left rail 126 and a right rail 127 of the trailer 120 over a range of longitudinal positions; a set of latches 133 configured to transiently engage a subset of engagement features 124, in the first array of engagement features 124 on the left rail 126 and in the second array of engagement features 124 on the right rail 127, to retain the bogie 130 below the trailer chassis 121 of the trailer 120; a driven axle 137 suspended from the chassis 132; and a motor 131 coupled to the driven axle 137 configured to output torque to the driven axle 137 in a tow mode and regeneratively brake the driven axle 137 in a regenerative braking mode.

In one variation, the left rail 126 and the right rail 127 of the trailer 120 are configured to run along a longitudinal axis 123 of the trailer 120, parallel to the longitudinal centerline, such that, when coupled to the bogie 130, a user (e.g., an operator, a driver, a technician) or a machine may manipulate the bogie 130 between the left rail 126 and the right rail 127 to guide the bogie 130 to a target position below the trailer chassis 121 and/or to remove the bogie 130 from the trailer 120 in a service mode.

### 2.2 Driven Axle+Motor

In one implementation, the driven axle 137 is supported by an axle housing, suspended from the trailer chassis 121, and includes a left driven wheel 138 and a right driven wheel 139. The axle housing further encapsulates a motor 131 mounted to the driven axle 137 and is configured to protect the driven axle 137 and the motor 131. In this implementation, the motor 131 is configured to drive the left driven wheel 138 and the right driven wheel 139 and thus, output torque in a tow mode. The motor 131 is further configured to regeneratively brake the left driven wheel 138 and the right driven wheel 139 to slow motion of the trailer 120 in a regenerative braking mode.

In one variation, the trailer 120 includes a passive axle 134, suspended from the trailer chassis 121, adjacent the driven axle 137 and includes a left passive wheel 135 and a right passive wheel 136. In this variation, the left passive wheel 135 and the right passive wheel 136 are configured to assist motion of the trailer 120 when the left driven wheel 138 and the right driven wheel 139 are driven by the motor 131 in the tow mode.

### 3.3 Sensors+Communication Cable

The system 100 can further include a set of sensors 115 including force sensors (e.g., a strain gauge, an inertial measurement unit, a load cell), optical sensors (e.g., a one-dimensional depth sensor, a LIDAR sensor, an RGB camera), inertial sensors (e.g., an inertial measurement unit, an accelerometer, a gyroscope); pressure sensors (e.g., a strain gauge, a pressure gauge); and/or proximity sensors (e.g., an electromagnetic field sensor, a Hall effect sensor, a conductive sensor, an inductive sensor) coupled to the trailer chassis 121, the kingpin 110, or a rear impact guard 125.

In one variation, the trailer chassis 121 and/or the kingpin no can include an inertial measurement unit configured to output signals representing motion in pitch, roll, and yaw positions of the kingpin no and/or angular velocity of the trailer 120. The inertial measurement unit can then transmit these signals to the controller 160 to detect a condition of the trailer 120.

In another variation, the kingpin 110 can include: a load cell configured to output signals representing tension, compression, pressure, or torque applied to the kingpin 110 and transmit these signals to the controller 160.

In yet another variation, an array of proximity sensors 115 are coupled to and arranged on the rear impact guard 125 and configured to output signals representing presence and/or absence of an external charging element within a threshold distance of the rear impact guard 125. The array of proximity sensors 115 can then transmit these signals to the controller 160.

In another variation, an array of proximity sensors 115 are coupled to and arranged on the trailer chassis 121 and configured to output signals representing presence and/or absence of a vehicle restraint of a loading dock within a threshold distance of the trailer chassis 121. The array of proximity sensors 115 can then transmit these signals to the controller 160.

In yet another variation, the system 100 can include a set of pressure sensors 115 coupled to a gladhand of a brake line system and configured to output signals corresponding to air pressure of the brake line system of the trailer 120 from an air supply of the tow vehicle and transmit these signals to the controller 160.

Further, the system 100 can include a communication cable arranged on the first end of the trailer chassis. The communication cable is configured to couple to a communication port of the tow vehicle and to transfer non-optical data (e.g., engine speed, engine temperature, oil pressure, state of charge of battery pack, wheel speed), associated with a tow vehicle coupled to the trailer 120, to the controller 160. The controller 160 can then manipulate these non-optical data to detect a state of charge of the battery pack of the tow vehicle.

### 4. Charging Panel

Generally, the system 100 includes a charging panel 150 coupled to the trailer chassis 121 and arranged on the second end 129 of the trailer chassis 121 adjacent the battery assembly 140. The charging panel 150 is configured to inductively couple to an external charging element to receive energy from the external charging element, convert this energy into electrical energy, and route electrical energy to the controller 160. The controller 160 can then route electrical energy to the battery assembly 140 in a charge mode and thus, charge the battery assembly 140.

### 4.1 Inductive Charging

In one implementation, the charging panel 150 includes a rigid panel, a receiver multi-coil inductor 154, and a rectifier. The rigid panel is operable in an open position to form a target gap between the external charging element and the charging panel 150. The receiver multi-coil inductor 154 is arranged on the rigid panel and is configured to inductively couple to the external charging element to receive alternating current from the external charging element. The receiver multi-coil inductor 154 can further define a receiver axis and a first size. The receiver multi-coil inductor 154 can also include a conductive coil supported by the rigid panel and arranged about (e.g., encircling) a magnetic core. The rectifier is electrically coupled to the receiver multi-coil inductor 154 and is configured to convert alternating current into direct current and enable the charging panel 150 to route direct current to the controller 160 in order to route a portion of the direct current in a first direction to the battery assembly 140 of the trailer 120.

In one variation, the receiver multi-coil inductor 154 includes a set of windings of a conductive material such as copper or aluminum supported by the rigid panel of a non-metallic material and encircles a magnetic core of a ferromagnetic material such as silicon steel. In this variation, the magnetic core is configured to increase and/or guide the electromagnetic field, generated by the external charging element, in order to route electrical energy in a first direction toward the battery assembly 140 of the trailer 120.

In another variation, the receiver multi-coil inductor 154 includes a slit conductive coil (e.g., a pancake coil) of a copper or aluminum wire coil supported by the rigid panel and encircles a magnetic core of a ferromagnetic material, such as iron. In this variation, the receiver multi-coil inductor 154 further includes a sheet of a magnetic material, such as a nanocrystalline alloy, interposed between the rigid panel and the slit conductive coil. The sheet is configured to increase the oscillating magnetic field between the external changing element and the charging panel 150 and reduce energy loss in order to supply electrical energy in a first direction toward the battery assembly 140 of the trailer 120. Thus, the charging panel 150 can increase and guide an oscillating electromagnetic field from the external charging element, convert the oscillating electromagnetic field into electrical energy, and route electrical energy to the controller 160. The controller 160 can then direct electrical energy to the battery assembly 140 of the trailer 120 and thereby, charge the battery assembly 140, and increase the charge efficiency of the battery assembly 140.

However, the charging panel 150 can include a receiver multi-coil inductor 154 of any other conductive coil and any other magnetic core. The conductive coil and the magnetic core can include any other material and can be of any other form. Further, the receiver multi-coil inductor 154 can be supported by the rigid panel in any other way.

Additionally, the external charging element: is electrically coupled to a power source of a depot or a charging station of a loading dock; includes an emitter multi-coil inductor; and is configured to generate an oscillating electromagnetic field between the emitter multi-coil inductor 152 and the receiver multi-coil inductor 154 of the charging panel 150. The emitter multi-coil inductor 152 can further define a transmission axis and a size approximating the size of the receiver multi-coil inductor 154 of the charging panel 150. The receiver axis of the charging panel 150 is configured to align with the transmission axis of the external charging element to inductively couple the charging panel 150 to the external charging element. The charging panel 150 can then collect energy from the external charging element, convert this energy into electrical energy, and route the electrical energy to the controller 160 for distribution to the battery assembly 140 of the trailer 120, as shown in FIG. 1B.

### 4.2 Panel Actuator

The system 100 can further include an electromechanical, pneumatic, or hydraulic panel actuator 156 coupled to and arranged on the second end of the trailer chassis 121 and configured to actuate the charging panel 150.

In one implementation, the panel actuator 156 is interposed between the trailer chassis 121 and the charging panel 150 and is configured to advance the charging panel 150 from the trailer chassis 121 to an open position to form a target gap with the external charging element and retract the charging panel 150 to decouple the charging panel 150 from the external charging element.

In one variation, the panel actuator 156 is arranged on the second end of the trailer chassis 121 and is configured to downwardly pivot the charging panel 150 from the trailer chassis 121 to an open position to form a target gap between the external charging element and the charging panel 150 and to upwardly pivot the charging panel 150 to a closed position to decouple the charging panel 150 from the external charging element.

For example, the system 100 can include a pressure sensor 115 coupled to a gladhand of a brake line system and configured to output signals corresponding to air pressure of the brake line system of the trailer 120 from an air supply of the tow vehicle. Based on a first signal received from the pressure sensor 115, the controller 160 can detect absence of motion of the trailer and trigger the panel actuator 156 to advance the charging panel 150 from the trailer chassis 121 to an open position to form a target gap with the external charging element.

### 5. Battery Assembly

Generally, the system 100 further includes a battery assembly 140 configured to transiently install on the trailer 120 over a range of longitudinal positions and electrically couple to the trailer 120 by a power cable or integrated directly with the trailer chassis 121 in order to receive electrical energy and to supply electrical energy to the motor 131.

More specifically, the battery assembly 140 can further supply electrical energy to the motor 131 to output torque to the driven axle 137 in a tow mode, receive electrical energy, converted by the charging panel 150, to charge the battery assembly 140 in a charge mode, and source electrical energy from the motor 131 to slow motion of the driven axle 137 and charge the battery assembly 140. Further, the battery assembly 140 can include a set of modular batteries configured to engage with each other and fit within a battery frame. The battery frame is configured to fit below a standard trailer chassis 121 of a trailer 120 between the left rail 126 and the right rail 127 and thus, enable a user to quickly and repeatably install the battery assembly 140 or the set of modular batteries below a standard floor of any trailer 120. The set of modular batteries enables a user to selectively adjust the battery capacity of the battery assembly 140 as a function of a predicted distance traveled by the trailer 120, a weight distribution of the trailer 120, and/or a type of the trailer 120 (e.g., a dry van trailer, a refrigerated trailer).

In one implementation, the battery assembly 140 includes a set of latches 133 configured to: transiently engage a subset of engagement features 124, in the first array of engagement features 124 on the left rail 126 and in the second array of engagement features 124 on the right rail 127; and to retain the battery assembly 140 below the trailer chassis 121. In this implementation, each latch in the set of latches 133 can include a solenoid (e.g., an electromechanical solenoid, a pneumatic solenoid), or another electromechanical latch (e.g., an air pressure latch, a mechanical latch) operable in an engaged position and a disengaged position to transiently engage and/or disengage a corresponding engagement feature distributed along the left rail 126 and the right rail 127 of the trailer 120, as described above.

However, each modular battery in the battery assembly 140 can define any other shape and couple to the motor in any other way.

### 6. Controller

Generally, the controller 160 is coupled to the panel actuator 156 and sensors within the system 100, interfaces with the integrated controller of the kingpin 110 and executes methods and techniques described below to: selectively enter an operational mode (e.g., a charge mode, a tow mode); trigger the panel actuator 156 to extend the charging panel 150 to an open position in the charge mode and to retract the charging panel 150 to a closed position in the tow mode; monitor a state of charge of the battery assembly of the trailer 120 and/or of an energy storage system of an electric tow vehicle, a hybrid tow vehicle, and/or a secondary trailer coupled to the trailer 120; selectively route portions of electrical energy to the battery assembly and each energy storage system to charge the battery assembly and each energy storage system; and selectively operate the motor 131 of the bogie to output torque to the driven axle 137 and to slow motion of the driven axle 137.

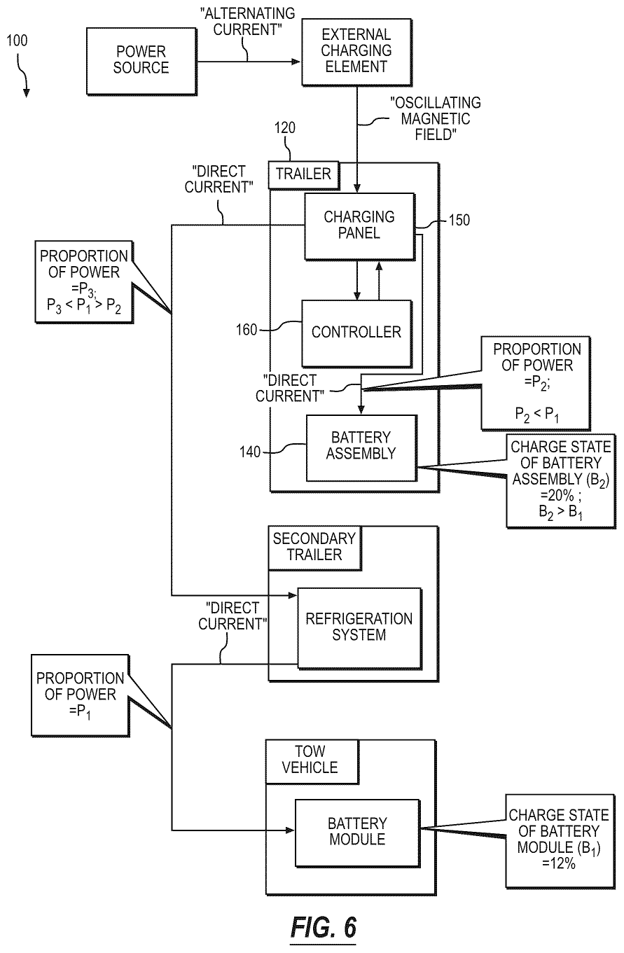

More specifically, in response to detecting presence of the external charging element within a threshold distance of the trailer 120 via proximity sensors 115, the controller 160 can enter a charge mode and trigger the panel actuator 156 to downwardly pivot the charging panel 150 from the trailer chassis 121 to an open position. Once in the charge mode, the controller 160 can: detect a state of charge of the battery assembly 140 of the trailer 120 and/or of an energy storage system of an additional electric tow vehicle or secondary trailer coupled to the trailer 120; and selectively direct portions of electrical energy, converted by the charging panel 150, to the battery assembly 140 of the trailer 120, to a battery pack of a tow vehicle coupled to the trailer 120, and/or to a battery module or electrical system of the secondary trailer based on these state of charges. Then, in response to detecting absence of the external charging element within the threshold distance of the trailer 120, the controller 160 can enter a tow mode and trigger the panel actuator 156 to upwardly pivot the charging panel 150 from the open position to a closed position facing the trailer chassis 121 to decouple the charging panel 150 from the external charging element. In the tow mode, the controller 160 can selectively operate the motor 131 of the bogie 130 to output torque to the driven axle 137 and/or slow motion of the driven axle 137, as shown in FIG. 6.

### 7. Charging Panel Configurations

Generally, the charging panel 150 is operable in an open position in a charge configuration to: collect energy from the external charging element; convert this energy into electrical energy; and route the electrical energy to the controller 160 for distribution throughout the system 100. The charging panel 150 is further operable in a closed position in a tow configuration to prevent damage to the charging panel 150 and reduce aerodynamic drag during motion of the trailer 120, as shown in FIGS. 2B, 2C, 3A, and 3B.

In one variation, the charging panel 150: is operable in the charge configuration; is pivoted downwardly from the trailer chassis 121, by the panel actuator 156, to an open position at a null-degree surge position and a null-degree sway position to form a target gap between the external charging element; and is inductively coupled to the external charging element in the charge configuration. The charging panel 150: is operable in the tow configuration; decoupled from the external charging element; and is pivoted upwardly from the open position to a closed position, by the panel actuator 156, to face the trailer chassis 121 in the tow configuration.

In another variation, the charging panel 150: is operable in the charge configuration; and is pivoted downwardly from the trailer chassis 121, by the panel actuator 156, to align the transmission axis of the emitter multi-coil inductor 152 of the external charging element and the receiver axis of the charging panel 150 in the open position and to form a target gap between the emitter multi-coil inductor 152 and the receiver multi-coil inductor, in the charge configuration.

In yet another variation, the battery assembly 140 and the charging panel 150 are configured to couple to the trailer chassis 121 over a range of longitudinal positions to balance a weight of the trailer 120. In particular, the battery assembly 140 can be arranged in a first longitudinal position below the trailer chassis 121, and the charging panel 150 can be arranged in a second longitudinal position on the second end 129 of the trailer 120 within a threshold distance of the battery assembly 140 to balance a weight of the trailer 120, containing a first load, on the driven axle 137.

Additionally, the controller 160 can autonomously enter the charge mode and trigger the panel actuator 156 to drive the charging panel 150 to the open position in the charge configuration. The controller 160 can also autonomously transition from the charge mode to a tow mode and trigger the panel actuator 156 to retract the charging panel 150 to the closed position in the tow configuration, as further described below.

### 7. Charge Mode

Generally, the user (e.g., an operator, a driver, a yard manager) operates the tow vehicle coupled to the trailer 120 in a reverse direction of motion to locate the second end of the trailer chassis 121 proximal a loading dock such that the trailer 120 occupies the loading dock and is prepared for unloading and/or loading of cargo. The controller 160 can interface with the integrated controller of the kingpin no to detect forces applied to the kingpin no by the hitch of the tow vehicle or detect presence of an external charging element or a vehicle restraint within a threshold distance of the trailer 120 via proximity sensors 115 to enter a charge mode and trigger the panel actuator 156 to advance the charging panel 150 from the trailer chassis 121 to an open position to couple the charging panel 150 to the external charging element.

In one implementation, the controller 160 can interface with the integrated controller of the kingpin 110 to: detect motion of the trailer 120 in a reverse direction such as toward a loading dock; calculate a direction and a magnitude of a force impulse applied to the kingpin no based on a signal received from the set of force sensors; and, in response to detecting the direction of the force impulse corresponding to the reverse direction of motion of the trailer 120, enter a charge mode and trigger the panel actuator 156 to advance the charging panel 150 from the trailer chassis 121 to the open position to couple the charging panel 150 to the external charging element.

### 7.1 Proximity Sensors+Inductive Charging

In one variation, the controller 160 can: access signals output by an array of proximity sensors 115 coupled to a rear impact guard 125 and detect presence or absence of the external charging element within a threshold distance of the rear impact guard 125. Responsive to detecting presence of the external charging element within the threshold distance of the rear impact guard, the controller 160 can autonomously enter a charge mode and trigger the panel actuator 156 to advance the charging panel 150 to a charge configuration to inductively couple with the external charging element.

In one implementation, the controller 160 can: detect absence of motion of the trailer 120 via an inertial measurement unit coupled to the trailer 120; access a signal from an array of proximity sensors 115 representing presence or absence of the external charging element within a threshold distance of the trailer 120; detect presence of the external charging element within the threshold distance of the rear impact guard 125; and, in response to detecting presence of the external charging element within the threshold distance of the rear impact guard 125, enter a charge mode and trigger the panel actuator 156 to downwardly pivot the charging panel 150 from the trailer chassis 121 to an open position, abutting a proximal face of the rear impact guard 125, to form a target gap between the external charging element and the charging panel 150. In the charge mode, the controller 160 can further calculate a coupling factor between the receiver multi-coil inductor of the charging panel 150 and the transmitter multi-coil inductor of the external charging element and, in response to the coupling factor falling within a target coupling factor range, the controller 160 can direct a maximum alternating current from the emitter multi-coil inductor 152 to the receiver multi-coil inductor.

For example, the charging panel 150 can be arranged on the second end 129 of the trailer chassis 121, aft of the bogie, and coupled to the trailer chassis 121. An operator of a tractor-trailer 120 may then drive the tractor-trailer 120 in a reverse direction of motion to maneuver the tractor-trailer 120 toward a loading dock and align the second end 129 of the trailer chassis 121 with the loading dock at a target position within a depot. Once the driver locates the second end 129 of the trailer chassis 121 at the target position, the controller 160 can: access a first signal from the array of proximity sensors 115; detect presence of the external charging element within the threshold distance of the rear impact guard 125; and, in response to detecting presence of the external charging element within the threshold distance of the rear impact guard 125, enter the charge mode and trigger the panel actuator 156 to downwardly pivot the charging panel 150 from the trailer chassis 121 to an open position, abutting a proximal face of the rear impact guard 125, to form a target gap between the charging panel 150 and the external charging element proximal the dock within the depot. Thus, the rear impact guard 125 can support and prevent damage to the charging panel 150 from external objects while the trailer 120 is docked and the charging panel 150 is inductively coupled to the external charging element in the open position.

In another variation, the controller 160 can: access signals output by an array of proximity sensors 115 coupled to the second end of the trailer chassis 121 and detect presence or absence of a vehicle restraint of a loading dock within a threshold distance of the trailer chassis 121. Responsive to detecting presence of the vehicle restraint within the threshold distance of the trailer chassis via the proximity sensors 115, the controller 160 can implement methods and techniques described above to enter a charge mode and trigger the panel actuator 156 to advance the charging panel 150 to a charge configuration to inductively couple with the external charging element.

Once in the charge mode, the controller 160 can: detect a distance between the receiver multi-coil inductor 154 of the charging panel 150 and the emitter multi-coil inductor 152 of the external charging element; calculate a coupling factor (e.g., a value between 0 and 1) based on a first size of the receiver multi-coil inductor, a second size of the emitter multi-coil inductor 152, and the distance between the receiver multi-coil inductor 154 and the emitter multi-coil inductor 152; and, in response to the coupling factor (e.g., 0.8) falling within a target coupling factor range (e.g., between 0.7 and 1), direct a maximum alternating current from the emitter multi-coil inductor 152 to the receiver multi-coil inductor 154. The controller 160 can then detect a state of charge of the battery assembly 140 (e.g., a numerical value, a percentage, a level) via the communication cable and distribute and direct electrical energy from the charging panel 150 to the battery assembly 140 of the tractor-trailer according to the state of charge, and thus charge the battery assembly 140 in the charge mode.

### 7.2 Power Distribution: Internal Combustion Engine Tractor+Trailer

In one variation, in the charge mode, the controller 160 can: detect a state of charge of the battery assembly 140 of the trailer 120; and, in response to the state of charge of the battery assembly falling below a threshold state of charge, selectively direct all electrical energy, converted by the charging panel 150, to the battery assembly 140 and thus, charge the battery assembly 140 of the trailer 120.

For example, the trailer 120 is coupled to a diesel engine tractor. The operator of this tractor trailer may wish to charge the battery assembly 140 of the trailer 120 while the trailer 120 is located at a loading dock and cargo, contained in the trailer chassis 121, is unloaded at the loading dock. The operator may then locate the second end 129 of the trailer chassis 121 at a target position and/or within a threshold distance of a loading dock at a warehouse. The controller 160 can then implement methods and techniques described above to enter a charge mode and trigger the panel actuator 156 to downwardly pivot the charging panel 150 from the trailer chassis 121 to the open position to inductively couple with an external charging element arranged proximal the loading dock. In the charge mode, the controller 160 can: detect a 30% state of charge of the battery assembly 140 of the trailer 120; and, in response to the 30% state of charge of the battery assembly 140 falling below a threshold state of charge of 75%, direct total electrical energy, converted by the charging panel 150, to the battery assembly 140 of the trailer 120, to charge the battery assembly 140. Later, the controller 160 can detect an 85% state of charge of the battery assembly 140 of the trailer 120; and, in response to the 85% state of charge of the battery assembly 140 exceeding the threshold state of charge of 75%, terminate power output from the external charging element to the charging panel 150 and trigger the panel actuator 156 to upwardly pivot the charging panel 150 from the open position to the closed position facing the trailer chassis 121. The operator may then drive the tractor trailer to the next destination.

Therefore, the controller 160 can monitor a state of charge of an individual battery assembly 140 of the trailer 120 to direct all electrical energy, converted by the charging panel 150, to the battery assembly 140 and thus, prioritize charging the battery assembly 140 of the trailer 120.

### 7.2 Charge Order

In one implementation, the controller 160 can access a charge order—defined by a user—that includes a set of charging rules or instructions prior to directing electrical energy to the battery assembly 140 of the trailer 120. Further, a user may wish to define a charge order with an ordered sequence of charging rules or instructions. In particular, a user may wish to charge the battery assembly 140 of the trailer 120 first and then charge a battery module of a hydrogen fuel cell tractor and/or an electric tractor coupled to the trailer 120 or vice versa. The user may also wish to define a maximum portion of electrical energy for the battery assembly 140 of the trailer 120 and a duration to charge the battery assembly 140.

In one variation, a user may wish to define a threshold state of charge and the controller 160 can define a first charge instruction to charge a battery characterized by a state of charge less than the threshold state of charge and a second charge instruction to charge a battery characterized by a state of charge greater than the threshold state of charge next. The controller 160 can then compile these charge instructions into a charge order and direct electrical energy to the battery pack of the tow vehicle and the battery assembly of the trailer 120.

For example, the controller 160 can access the charge order including: a first charge instruction indicating a first duration to direct a first portion of electrical energy to a battery pack of a tow vehicle; and a second charge instruction indicating a second duration for a second portion of electrical energy, less than the first portion of electrical energy, to the battery assembly 140 of the trailer 120. The controller 160 can then: detect a hitch of a tow vehicle coupled to the trailer 120 via the kingpin 110; detect a first state of charge of a battery pack of the tow vehicle; detect a second state of charge of the battery assembly 140 of the trailer 120; based on the first charge instruction, direct the first portion of electrical energy to the battery pack of the tow vehicle for the first duration; and, based on the second charge instruction, direct the second portion of electrical energy, less than the first portion, to the battery assembly 140 of the trailer 120 for the second duration.

Alternatively, the user may wish to define: a first rule to charge a battery within a first state of charge range, such as between a 0% state of charge and a 30% state of charge at a first time; a second rule to charge a second battery within a second state of charge range between a 30% state of charge and a 60% state of charge at a second time succeeding the first time; and a third rule to charge a third battery within a third state of charge range between a 60% state of charge and a 90% state of charge at a third time succeeding the second time. Thus, the user can define a charge order with an ordered sequence of rules and the controller 160 can access and implement the ordered sequence of rules in the charge mode.

For example, the controller 160 can: detect a hydrogen fuel cell tractor with a battery module and a secondary trailer with a secondary battery assembly coupled to the trailer 120; detect a first state of charge of the battery module of the hydrogen fuel cell tractor via the communication cable; detect a second state of charge of the battery assembly 140 of the electric trailer 120; and detect a third state of charge of the secondary battery assembly of the trailer 120. Then, in response to detecting the second state of charge of the battery assembly 140 of the trailer 120 falling below the threshold state of charge, the third state of charge of the secondary battery assembly exceeding the threshold state of charge, and the first state of charge of the battery module exceeding the second state of charge of the battery assembly 140 and falling below the threshold state of charge, the controller 160 can: define a charge order to charge the battery assembly 140 of the trailer 120 and then the battery module of the hydrogen fuel cell tractor.

Therefore, the controller 160 can access a charge order defined by the user or define a charge order according to a threshold state of charge defined by the user. The controller 160 can then direct electrical energy: to the battery assembly of the trailer 120 to charge the battery assembly 140 of the trailer 120; and/or to an energy storage system of an additional tow vehicle or secondary trailer coupled to the trailer 120 according to the charge order.

### 7.4 Power Distribution: Electric Tractor+Trailer

In one variation, in the charge mode, the controller 160 can: detect a hitch of a tow vehicle coupled to the trailer 120 via the kingpin 110; detect a state of charge of the battery assembly 140 of the trailer 120; detect a state of charge of an energy storage system—such as a battery pack, a battery module, or a battery assembly—of the tow vehicle; and access a charge order defining a set of charging rules or instructions. The controller 160 can then identify a charging rule or instruction corresponding to each state of charge and direct a corresponding portion of electrical energy, defined in the charge order, to the battery assembly 140 of the trailer 120 and to the energy storage system of the tow vehicle.

In one implementation, the trailer chassis 121 can include a tractor port 122 arranged on the first end 128 of the trailer chassis 121 proximal the kingpin 110 and configured to receive an electrical cable from the hybrid tractor to electrically couple the electric tractor to the trailer 120. The electrical cable defines a first end coupled to a cable receptacle of the tow vehicle and a second end, opposite the first end, configured to transiently couple to the tractor port 122 of the trailer 120 in the charge mode. The electrical cable is further housed in a spring-loaded spool on the tractor and configured to transiently house a section interposed between the first end and the second end of the electrical cable. The spring-loaded spool is configured to: extend the cable from the tow vehicle toward the tractor port 122 on the trailer 120 to an engaged position responsive to application of a first downward force on the second end of the cable; and retract the cable toward the tow vehicle to a disengaged position responsive to application of a second downward force on the second end of the cable. The controller 160 can then: distribute a portion of electrical energy from the charging panel 150 of the trailer 120, through the electrical cable, and to the battery module of the electric tractor; and distribute a different portion of electrical energy to the battery assembly 140 of the trailer 120.

For example, the trailer 120 is coupled to an electric tractor with a battery module. The operator of this tractor-trailer may wish to charge the battery assembly 140 of the trailer 120 and the battery module of the electric tractor while the tractor-trailer is stored in a depot for a period of time such as ten hours. In charge mode, at a first time, the controller 160 can then: detect a hitch of the electric tractor coupled to the trailer 120 via the kingpin no; detect the second end of the electrical cable conductively coupled to the tractor port 122 of the trailer 120 in the engaged position; detect a first state of charge of the battery module of the electric tractor via the communication cable; detect a second state of charge of the battery assembly 140 of the trailer 120; and, in response to the second state of charge of the battery assembly 140 of the trailer 120 exceeding the first state of charge of the battery module of the electric tractor, direct a first portion of electrical energy to the battery module of the electric tractor via the cable and direct a second portion of electrical energy, less than the first portion, to the battery assembly 140 of the trailer 120.

At a second time, the controller 160 can detect a third state of charge, greater than the first state of charge, of the battery module of the electric tractor via the communication cable; detect a fourth state of charge, greater than the second state of charge, of the battery assembly 140 of the trailer 120; in response to detecting the third state of charge of the battery module of the electric tractor exceeding the fourth state of charge of the battery assembly 140 of the trailer 120, direct a third portion of electrical energy, less than the first portion, to the battery module of the hybrid tractor; and direct a fourth portion of electrical energy, greater than the first portion, to the battery assembly 140 of the trailer 120. Thus, the controller 160 can prioritize charging the battery module of the electric tractor, which may be coupled to the trailer 120 for a short time duration via the cable and manage the state of charge of the battery assembly 140 of the trailer 120, which may occupy a loading dock for a longer time duration.

Therefore, the controller 160 can monitor the state of charge of a tow vehicle and a trailer 120 to selectively direct portions of electrical energy to simultaneously charge the battery module of a tow vehicle coupled to the trailer 120 and to charge the battery assembly 140 of the trailer 120 in the charge mode. Additionally, the controller 160 can prioritize charging the battery module of the electric tractor and manage the state of charge of the battery assembly of the trailer 120 in preparation for a subsequent trip.

### 7.5 Power Distribution: Electric Tractor+Trailer+Secondary Trailer

In one variation, the controller 160 can: detect the trailer 120 coupled to the hitch of the tow vehicle via the kingpin 110 and coupled to a secondary trailer via the trailer coupler; detect a state of charge of the battery assembly 140 of the trailer 120; detect a state of charge of an energy storage system—such as a battery pack, a battery module, or a battery assembly—of the tow vehicle; and access the charge order defining a set of charging rules or instructions via the communication cable. The controller 160 can then identify a charging rule or instruction corresponding to each state of charge and direct a corresponding portion of electrical energy, defined in the charge order and converted by the charging panel 150: to the battery assembly 140 of the trailer 120; to a secondary battery assembly of the secondary trailer; and/or additional electrical systems coupled to the secondary trailer, such as a refrigeration system according to the charge order and each state of charge.

In one example, the trailer 120 is coupled to a secondary dry van trailer with a secondary battery assembly via the vehicle coupler and is communicatively coupled to an electric tractor with a battery pack to form a tandem combination vehicle. In the charge mode, the controller 160: detects the trailer chassis 121 coupled to the secondary trailer; detects a first state of charge of a battery pack of the electric tractor via the communication cable; detects a second state of charge of the battery assembly 140 of the trailer 120; and detects a third state of charge of a secondary battery assembly of the secondary trailer. Then, in response to the second state of charge of the battery assembly 140 exceeding the first state of charge of the battery pack and, in response to the third state of charge of the secondary battery assembly exceeding the second state of charge of the battery assembly 140, the controller 160: directs a first portion of electrical energy, converted by the charging panel 150, to the battery pack of the electric tractor; directs a second portion of electrical energy, less than the first portion, to the secondary battery assembly of the secondary trailer; and directs a third portion of electrical energy, less than the second portion, to the battery assembly 140 of the trailer 120.

In another example, the trailer 120 is coupled to a electric tractor with a battery pack and a secondary refrigerated trailer with a refrigeration system configured to maintain a target temperature range of perishable cargo contained in the secondary refrigerated trailer. In charge mode, the controller 160: detects the trailer chassis 121 coupled to the electric tractor via the vehicle coupler 110 and coupled to the refrigerated trailer via the trailer coupler; detects the first state of charge of the battery pack of the electric tractor; and detects the second state of charge of the battery assembly 140 of the trailer 120. Then, in response to the second state of charge of the battery assembly 140 of the trailer 120 exceeding the first state of charge of the battery pack of the electric tractor, the controller 160: directs the first portion of electrical energy to the battery pack of the electric tractor to charge the battery pack; directs the second portion of electrical energy, less than the first portion, to a refrigeration system of the refrigerated trailer; and directs a third portion of electrical energy, less than the second portion, to the battery assembly 140 of the trailer 120 to charge the battery assembly 140.

Therefore, the controller 160 can monitor the state of charge of a tow vehicle and a set of trailers 120 to selectively direct portions of electrical energy to simultaneously charge the battery pack of an electric tractor, the battery assembly 140 of the trailer 120, and a secondary battery assembly of a secondary trailer. Additionally, the controller 160 can direct a portion of electrical energy to a refrigeration system of a secondary refrigerated trailer in the charge mode and thus, prioritize charging the battery pack of the electric tractor and manage the state of charge of the battery assembly of the trailer 120 in preparation for a subsequent trip and to supply power to the refrigeration system of the secondary trailer.

### 8. Variation: Charging Panel on Battery Assembly

In one variation, the charging panel 150 can be coupled to the battery assembly 140 of the trailer 120 and configured to inductively couple to an external charging element arranged below the trailer chassis 121.

In one implementation, the charging panel 150 includes an emitter multi-coil inductor 152 and a rigid panel. The rigid panel is configured to extend from the battery assembly 140 to an open position toward a ground surface below the trailer 120 and inductively couple to an external charging element located below the trailer chassis 121, arranged on and/or embedded within the ground surface.

For example, the charging panel 150 can include a copper pancake coil coupled to the rigid panel. The external charging element is electrically coupled to a power source of a depot and includes a charging pad and an emitter multi-coil inductor 152 arranged within the charging pad. The charging pad is arranged on the ground surface of the depot and defines a width greater than a diameter of the copper pancake coil and less than a width of the driven axle 137 of the trailer 120 such that a user can drive the trailer 120 to a target position over the charging pad to align a receiver axis of the charging panel 150 and the transmission axis of the external charging element. The external charging element can generate an oscillating electromagnetic field between the emitter multi-coil inductor 152 and the receiver multi-coil inductor 154 of the charging panel 150. The controller 160 can then implement methods and techniques described above to direct electrical energy to the battery assembly 140 of the trailer 120.

Alternatively, the charging pad can be arranged on a dolly and an operator can maneuver the dolly to a target position below the trailer chassis 121 to align a receiver axis of the charging panel 150, coupled to the battery assembly 140, and the transmission axis of the external charging element. The external charging element can then generate an oscillating electromagnetic field between the emitter multi-coil inductor 152 and the receiver multi-coil inductor 154 of the charging panel 150. The controller 160 can then implement methods and techniques described above to direct electrical energy to the battery assembly 140 of the trailer 120. Once the battery assembly 140 is charged, the operator may remove the dolly and the charging pad from the target position and the controller 160 can enter a tow mode.

### 9. Variation: Multiple Charging Panels

In another variation, the system 100 can include a set of charging panels 150 configured to couple to a corresponding external charging element. The controller 160 can then direct portions of electrical energy to the battery assembly 140 of the trailer 120 to charge the battery assembly 140 in charge mode. Alternatively, the controller 160 can direct a portion of electrical energy, converted by each charging panel 150, to the battery assembly 140 of the trailer 120 and to an energy storage system of a tow vehicle coupled to the trailer 120.

For example, the system 100 can include a first charging panel 150 coupled to the trailer chassis 121, arranged on the second end 129 of the trailer chassis 121, and configured to couple to the external charging element as described above. The system 100 can further include a second charging panel 150 coupled to the battery assembly 140 and configured to inductively couple to a second external charging element located below the trailer chassis 121 and embedded within a ground surface. The controller 160 can then implement methods and techniques described above to: trigger the second charging panel 150 to advance from the battery assembly 140 to the charging pad in an open position; detect a first state of charge of a battery pack of the tow vehicle; detect a second state of charge of the battery assembly 140 of the trailer 120; and, in response to the second state of charge of the battery assembly 140 of the trailer 120 exceeding the first state of charge of the battery pack of the tow vehicle, direct a first portion of electrical energy, converted by the first charging panel 150, to the battery pack of the tow vehicle and direct a second portion of electrical energy, less than the first portion, to the battery assembly 140 of the trailer 120. The controller 160 can then: detect a third state of charge of the battery assembly 140 of the trailer 120; and, in response to the third state of charge of the battery assembly 140 of the trailer 120 falling below a threshold state of charge, direct a third portion of electrical energy, converted by the second charging panel 150, to the battery assembly 140.

Then, the controller 160 can detect a fourth state of charge of the battery assembly 140 of the trailer 120 and, in response to the fourth state of charge of the battery assembly 140 of the trailer 120 exceeding the threshold state of charge: terminate electrical energy output at each external charging element; trigger the panel actuator 156 to retract the first charging panel 150 upwardly to the closed position to face the trailer chassis 121 and decouple from the external charging element; and trigger the second panel actuator to retract the second charging panel 150 from the charging pad to the battery assembly 140 in a closed position.

Therefore, the controller 160 can direct portions of electrical energy, converted by multiple charging panels 150, to the battery assembly of the trailer 120 and the battery pack of the tow vehicle in order to simultaneously charge the battery assembly of the trailer 120 and the battery pack of the tow vehicle in preparation for a subsequent trip.

### 10. Tow Mode

Generally, at the end of charge mode, the controller 160 can interface with the integrated controller of the kingpin 110 to detect forces applied to the kingpin 110 by the hitch of the tow vehicle, trigger the panel actuator 156 to upwardly pivot the charging panel 150 to the closed position, and enter a tow mode. In particular, the controller 160 can interface with the integrated controller of the kingpin no to: calculate a direction and a magnitude of a force applied to the kingpin no based on a signal received from the set of force sensors; and, in response to detecting the direction of the force opposite to the direction of an initial coupling force applied to the kingpin 110, trigger the panel actuator 156 to upwardly pivot the charging panel 150 from the open position to a closed position facing the trailer chassis 121 and enter a tow mode.

In one implementation, in tow mode, the controller 160 can detect conditions of the trailer 120 such as a including: a direction of motion of the trailer 120; a tractor-trailer angle (e.g., a steering angle); a speed of the trailer 120; an incline angle of the trailer 120 (e.g., a grade of a ground surface); a location of the trailer 120; forces applied to the kingpin 110 (e.g., lateral forces, longitudinal forces, total forces); and a state of charge of the battery assembly 140 of the trailer 120. The controller 160 can then: calculate a target preload force proportional to and/or inversely proportional to the condition of the trailer 120; and trigger the motor 131 to increase torque output and/or reduce torque output in the direction of motion of the trailer 120 to decrease a difference between the target preload force and a total force applied to the kingpin 110 to control the trailer 120 in conjunction with the tow vehicle.

In one variation, the controller 160 can: detect a state of charge of the battery assembly 140 of the trailer 120; adjust target torque output proportional to the state of charge of the battery assembly 140; and calculate a target preload force inversely proportional to the state of charge of the battery assembly 140.

### 10.1 Dynamic Target Preload Force: State of Charge of Battery

In one variation, the controller 160 can detect a “real-time” state of charge of the battery assembly 140 coupled to the trailer 120. Further, the controller 160 can then detect a state of charge of the battery assembly 140 as a condition of the trailer 120 and selectively adjust a target preload force inversely proportional to the state of charge.

For example, during a first time period, the controller 160 can: detect a first longitudinal force applied to the kingpin no by the hitch of the tow vehicle; detect a first lateral force applied to the kingpin 110 by the hitch; detect a forward direction of motion and a first speed of the trailer 120; detect a first state of charge of 55% of the battery assembly 140; detect a first tractor-trailer angle; calculate a first total force, applied to the kingpin 110 by the hitch, based on the first longitudinal force and the first lateral force; calculate a first target preload force opposite the first direction of motion (e.g., a reverse direction) proportional to the tractor-trailer angle and inversely proportional to the first state of charge of 55% of the battery assembly 140; and, in response to the first total force falling below the first target preload force, trigger the motor 131 to reduce torque output in the forward direction of motion to decrease a first difference between the first total force and the first target preload force.

During a second time period, the controller 160 can: detect a second longitudinal force applied to the kingpin no by the hitch of the tow vehicle; detect a second lateral force applied to the kingpin no by the hitch; detect a forward direction of motion and a second speed of the trailer 120; detect a second tractor-trailer angle less than the first tractor-trailer angle; detect a second state of charge of 75% of the battery assembly 140 greater than the first state of charge of 55% of the battery assembly 140; calculate a second total force, applied to the kingpin no by the hitch, based on the second longitudinal force and the second lateral force; calculate a second target preload force in a reverse direction of motion proportional to the second tractor-trailer angle and inversely proportional to the second state of charge of 75% of the battery assembly 140; and, in response to the second total force exceeding the target preload force, trigger the motor 131 to reduce torque output in the forward direction of motion to decrease a second difference between the first total force and the first target preload force.

In another variation, the controller 160 can access a drive route assigned to the trailer 120 and predict a state of charge of the battery assembly 140 at the start of the tow mode. In particular, an operator may define a start location and an end location for a drive route and upload this drive route to a user interface. The controller 160 can then: access the drive route; estimate a set of legs between the start location and the end location for the drive route; and populate each leg of the drive route with a time window, a corresponding georeferenced location, and emission conditions associated with the georeferenced location. The computer system can then access this drive route at the start of the tow mode. Then for each leg of the drive route, the controller 160 can autonomously increase or decrease the target preload force at the kingpin 110 proportional to the predicted state of charge of the battery assembly 140 associated with each leg of the drive route.

Therefore, the controller 160 can monitor a “real-time” state of charge or a predicted state of charge of the battery assembly 140 and, accordingly, increase or decrease the target preload force and thereby, increase the life of the battery assembly 140 and reduce emissions by the tow vehicle in the tow mode.

### 11. Variation: Conductive Charging

In one variation, the charging panel 150 is configured to conductively couple to the external charging element to receive energy from the external charging element, convert this energy into electrical energy, and route electrical energy to the controller 160. The controller 160 can then implement methods and techniques described above to route electrical energy to the battery assembly 140 in a charge mode and thus, charge the battery assembly 140.

In one example, the charging panel 150 is coupled to the trailer chassis 121 and arranged on the second end 129 of the trailer chassis 121. The charging panel 150 further includes a conductive interface configured to couple with a cross-rail external charging element located above the trailer 120 within a loading dock. Responsive to detecting presence of a vehicle restraint of the loading dock within a threshold distance of the trailer chassis 121 via the set of proximity sensors 115, the controller 160 triggers the panel actuator 156 to extend the charging panel 150 from the trailer chassis 121 to an open position in order to conductively couple the charging panel 150 to the cross-rail external charging element located above the trailer 120. The controller 160 then implements methods and techniques described above to route electrical energy to the battery assembly 140 of the trailer 120, the energy storage unit of a tow vehicle coupled to the trailer 120, and/or an electrical system of a secondary trailer in the charge mode. At the end of charge mode, the controller 160 triggers the panel actuator 156 to retract the charging panel 150 from the open position to a closed position proximal the trailer chassis 121 in order to decouple the charging panel 150 from the cross-rail external charging element.

In another example, the trailer 120 defines a cuboid structure and includes a lower face coupled to the trailer chassis 121 and an upper face opposite the lower face. In this example, the charging panel 150 is arranged on the upper face of the cuboid structure and includes a conductive pantograph interface configured to couple with a charging element located above the trailer 120 within a loading dock. Responsive to detecting presence of a vehicle restraint of the loading dock within a threshold distance of the trailer chassis 121 via the set of proximity sensors 115, the controller 160 triggers the panel actuator 156 to extend the charging panel 150 from the trailer chassis 121 to an open position, above the trailer 120, in order to conductively couple the pantograph interface of the charging panel 150 to the external charging element located above the trailer 120. At the end of the charge mode, the controller triggers the panel actuator 156 to retract the charging panel 150 from the open position to a closed position proximal the trailer chassis 121 in order to decouple the charging panel 150 from the external charging element.

However, the charging panel 150 can include any other type of electrical cable or any other type of charging interface and can conductively couple to an external charging element in any other way.

### 12. Method

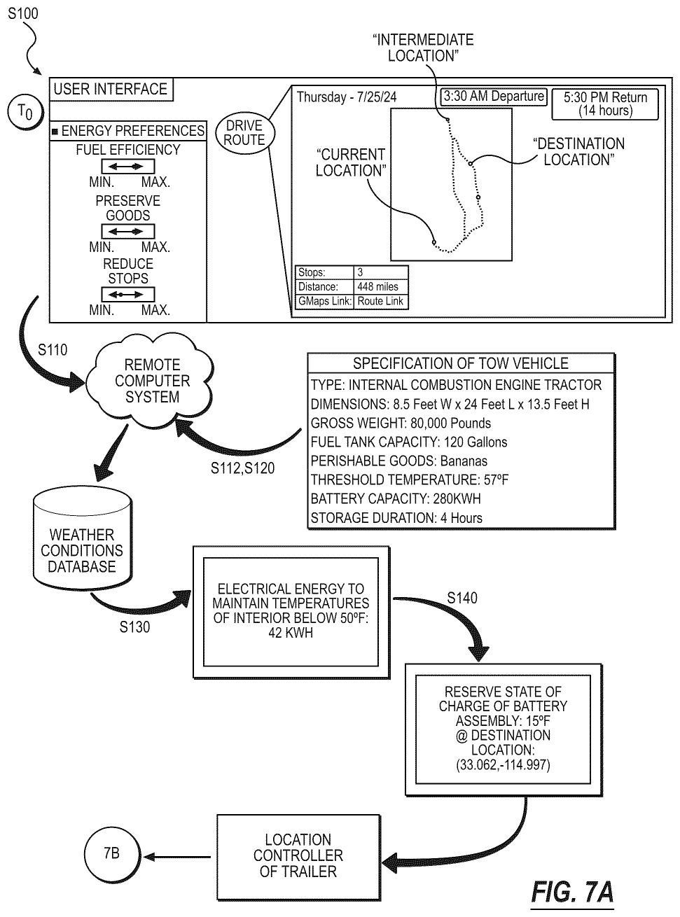

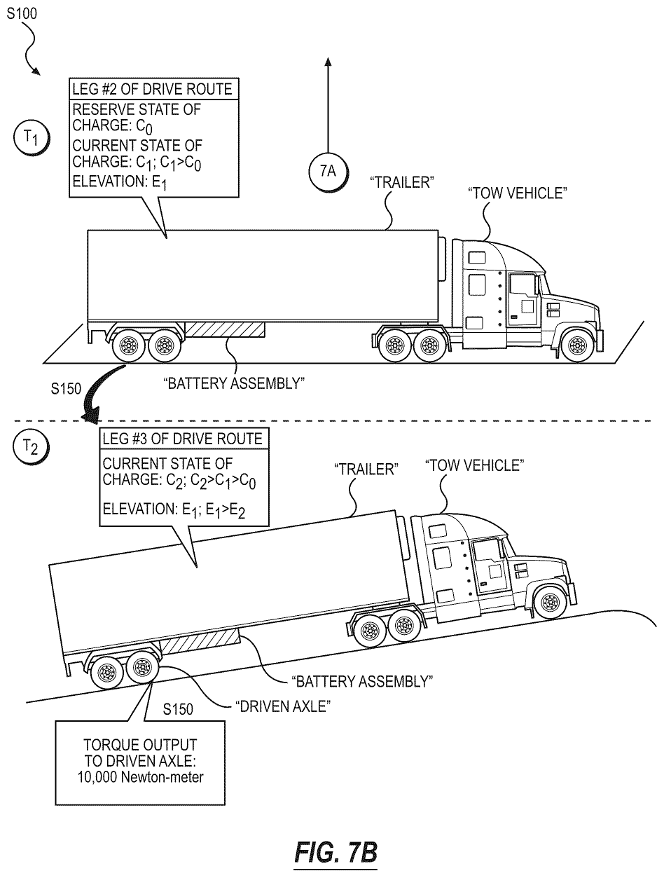

As shown in FIGS. 7A and 7B, a method for monitoring energy of a trailer includes: accessing a drive route for the refrigerated trailer between a current location and a destination location in Block Silo; accessing a target temperature range for an interior of the refrigerated trailer containing a set of goods in Block S112; predicting a time duration between arrival of the refrigerated trailer at the destination location and unloading of the set of goods in Block S120; estimating a quantity of electrical energy to maintain temperatures of the interior refrigerated trailer within the target temperature range for the time duration in Block S130; and calculating a target state of charge of a battery assembly of the refrigerated trailer to supply the quantity of electrical energy to a refrigeration system to modulate temperatures of the interior of the refrigerated trailer in Block S140.

The method S100 further includes, during traversal of the drive route by the refrigerated trailer coupled to a tow vehicle: selectively outputting torque to the driven axle to increase fuel efficiency of the tow vehicle in Block S150; and selectively regeneratively braking the driven axle to recharge the battery assembly and to achieve the target state of charge of the battery assembly upon arrival of the refrigerated trailer at the destination location in Block S160.

### 12.1 Variation: User-Defined Energy Preferences

One variation of the method S100 includes: accessing a drive route for the refrigerated trailer between a current location and a destination location in Block Silo; receiving a set of energy preferences for the drive route from a user via a user interface; accessing a target temperature range for an interior of the refrigerated trailer containing a set of goods in Block S112; predicting a time duration between arrival of the refrigerated trailer at the destination location and unloading of the set of goods in Block S120; estimating a quantity of electrical energy to maintain temperatures of the interior refrigerated trailer within the target temperature range for the time duration in Block S130; and calculating a target state of charge of a battery assembly of the refrigerated trailer to supply the quantity of electrical energy to a refrigeration system to modulate temperatures of the interior of the refrigerated trailer in Block S140.

This variation of the method S100 further includes, during traversal of the drive route by the refrigerated trailer coupled to a tow vehicle: selectively outputting torque to the driven axle to achieve the set of energy preferences in Block S150; and selectively regeneratively braking the driven axle to achieve the target state of charge of the battery assembly upon arrival of the refrigerated trailer at the destination location in Block S160.

### 12.2 Variation: Emissions Regulation Zone

One variation of the method S100 includes: accessing a drive route for the refrigerated trailer between a current location and a destination location in Block Silo; identifying an emissions regulation zone intersecting the drive route; accessing a emissions threshold for a tow vehicle, hauling the refrigerated trailer, within the emissions regulation zone in Block S112; estimating a total energy to traverse a leg of the drive route within the emissions regulation zone in Block S130; calculating a maximum energy from liquid fuel, available to the tow vehicle within the emissions regulation zone, based on the emissions threshold; calculating a minimum electrical energy stored in a battery assembly of the refrigerated trailer, upon entering the emissions regulation zone, based on a difference between the total energy and the maximum energy from liquid fuel; and allocating the minimum quantity of energy, stored in the battery assembly, to torque output by a motor of the refrigerated trailer to assist the tow vehicle while traversing the emissions regulation zone and to maintain emissions by the tow vehicle below the threshold emissions while traversing the emissions regulation zone in Block S150.

This variation of the method S100 further includes, during traversal of the drive route by the refrigerated trailer coupled to a tow vehicle: selectively outputting torque to the driven axle to increase fuel efficiency of the tow vehicle in Block S150; and selectively regeneratively braking the driven axle to achieve the target state of charge of the battery assembly upon arrival of the refrigerated trailer at the destination location in Block S160.

### 12.2 Variation: Drive Route Segmentation

One variation of the method S100 includes, during a setup period: receiving a drive route for a tractor-trailer defining a start location, a destination location, and a target condition for the drive route in Block Silo; based on the target condition, assigning a trailer type and a battery capacity of a battery assembly associated with the trailer type to the drive route; and segmenting the drive route into a set of legs representing zones between the start location and the destination location. The method S100 further includes, for each leg in the set of legs: accessing a set of environmental conditions for the leg from an environmental condition database; calculating a nominal environmental condition for the leg based on the set of environmental conditions; accessing an elevation profile for the leg from a topographical database; based on the nominal environmental condition and the elevation profile, defining an operational mode (e.g., “torque output assist,” “battery recharging,” or “drag charging”) perimeter to achieve the target condition for the drive route; and assigning the operational mode perimeter to the leg of the drive route. The method S100 also includes: modifying the drive route with the set of legs; annotating the set of legs with locations and operational mode perimeters; and transmitting the drive route a controller of the trailer for execution.

The method S100 further includes, during a first time period: detecting a first geospatial location of the tractor-trailer proximal the drive route; detecting a first state of charge of the battery assembly of the trailer; and, in response to the first geospatial location of the tractor-trailer falling within a torque output assist perimeter, prioritizing torque output assist by the motor to the driven axle of the trailer in Block S150.

The method S100 also includes, during a second time period: detecting a second geospatial location of the tractor-trailer proximal the drive route; and, in response to the second geospatial location falling within a battery recharging perimeter, prioritizing regenerative braking to charge the battery assembly in Block S160.

The method S100 further includes, during a third time period: detecting a third geospatial location of the tractor-trailer proximal the drive route; detecting a speed of the tractor-trailer; and, in response to the third geospatial location falling outside of an operational mode perimeter and, in response to the speed falling below a threshold speed, disabling torque output by the motor to reduce power consumption by the trailer.

### 13. Applications

Generally, a computer system (e.g., a remote server, a remote computer system) can execute Blocks of the method S100: to access a drive route for a tractor-trailer transporting goods between a start location and a destination location entered by a user (e.g., a customer, a fleet manager, an operator) via a user interface; to receive energy preferences entered by the user; to estimate energy needs—such as electrical energy to maintain goods within a target temperature range and a reserve battery state of charge to supply the electrical energy to an internal refrigeration system of the trailer—during and after completion of the drive route; and to cooperate with a local controller of the trailer to selectively alternate between operational modes (e.g., torque output assist mode, regenerative braking mode, drag charging mode, disable torque output) during the drive route to achieve these energy preferences and needs.

More specifically, the computer system can receive a drive route defining a start location and a destination location from a user via the user interface. The user can define the start location, the destination location, and intermediate locations (e.g., stops) within a map depicting a geographical region between the start location and the destination location. The user can further define a set of target conditions (or “energy preferences”)—such as increase fuel efficiency, reduce stops along the drive route, preservation of goods contained in an internal refrigeration system of the trailer, a target state of charge of a battery assembly on the trailer, and/or compliance with regulatory requirements—for the drive route within the user interface.

Additionally, the computer system can interface with the user interface to receive a target temperature range for goods contained in the interior of the refrigerated trailer. Accordingly, the computer system can predict a time duration (e.g., a storage duration) between arrival of the trailer at the destination location and unloading of the set of goods. The computer system can further: estimate a quantity of electrical energy to maintain temperatures of the interior of the trailer within the target temperature range for the time duration; and calculate a reserve or a minimum state of charge of the battery assembly of the trailer to supply this quantity of electrical energy to the internal refrigeration system of the refrigerated trailer. Thus, by calculating a reserve state of charge of the battery assembly, the computer system can enable the trailer to prevent loss or spoiling of the goods during the drive route or during extended periods of time to store these goods at the destination location.

### 13.1 Operational Modes During Traversal of Drive Route

During traversal of the drive route, the local controller can selectively prioritize torque output assist or regenerative braking in order to achieve the set of energy preferences defined by the user and to achieve the reserve state of charge of the battery assembly upon arrival of the trailer at the destination location.

In particular, during traversal of the drive route by the tow vehicle hauling the refrigerated trailer, the local controller can access geospatial location data, speed data, fuel consumption data, state of charge of the battery assembly data, and energy consumption data via sensors coupled to the trailer chassis and autonomously prioritize torque output assist by the motor to the driven axle, prioritize regenerative braking to charge the battery assembly, reduce torque output, or disable torque output to reduce power consumption by the trailer according to these data.

Furthermore, in the torque output assist mode, the local controller can selectively trigger the battery assembly to supply electrical energy to the motor to increase torque output to the driven axle in order to: assist forward tractor motion and achieve the set of energy preferences defined by the user. In the regenerative braking mode, the local controller can selectively trigger the motor to supply electrical energy to the battery assembly in order to recharge the battery assembly and to achieve the reserve state of charge of the battery assembly during the drive route and upon arrival of the trailer at the destination location.

Therefore, the computer system can cooperate with the local controller to set operational modes of the trailer along a drive route in order: to reduce fuel consumption of a tractor hauling the trailer; to increase fuel efficiency of the tractor hauling the trailer along the drive route; to augment braking of the tractor and trailer during hauling; to maintain a reserve state of charge of the battery assembly of the trailer; to maintain temperatures of goods stored within an interior of the trailer within a target temperature range during traversal of the drive route; and/or to ensure that the battery assembly supplies electrical energy to the internal refrigeration system to maintain temperatures of goods within the target temperature range following completion of the drive route (e.g., regardless of separation of the tractor from the trailer and absence of grid power supplied to the trailer at the destination location).

### 12.2 Pre-Planning Operational Modes Along Drive Route

In one example, the computer system can: receive a drive route specifying a start location and a destination location within a geographic region, such as entered by a user (e.g., a customer, a fleet manager, an operator) via a user interface; segment the drive route into a set of legs, representing distances between the start location and the destination location; to assign a trailer type and a capacity of a battery assembly associated with the trailer type to the drive route; to access topographical data, environmental condition data, speed limit data, recharging availability, and regulatory requirements (e.g., emissions requirements, noise requirements, or environmental requirements) data for locations within these legs; to access or estimate energy needs (e.g., to maintain cooling or heating in a refrigerated trailer) during these legs; and, based on these data, define and assign a particular operational mode perimeter (e.g., zone) for the trailer during each leg.

More specifically, the computer system and the local controller can cooperate to define: target zones specifying a torque assist mode in which the trailer prioritizes torque output assist of a motor in an axle of the trailer to assist forward tractor motion; target zones specifying a battery recharging mode in which the trailer prioritizes regenerative braking or drag charging by the motor in an axle of the trailer to recharge a battery in the trailer; and target zones specifying a non-operational mode in which the trailer disengages a motor drive, disables torque output and/or disables regenerative braking in order to reduce power consumption by the trailer and reduce rolling drag of the trailer (e.g., shift from a drive gear to a neutral gear at the driven axle).

Furthermore, the computer system can specify torque output assist modes in geographic regions with regulatory requirements (e.g., emissions or noise regulations) and/or elevation increases. In this example, the computer system can also specify battery recharging modes: in geographic regions with elevation decreases; in geographic regions with the preceding regulatory requirements (e.g., an idling duration, a congestion fee, a sound ordinance, an emissions limit) and/or elevation increases; and at a terminus or the destination location of the drive route at which the trailer is required to power an internal refrigeration system, via a diesel-powered refrigeration subsystem or an electrical refrigeration subsystem, for an extended period of time.

The computer system can also: assign each target zone to a corresponding leg of the drive route; estimate a completion duration for the tractor-trailer to traverse the set of legs; and modify the drive route with the set of legs. The computer system can then: present the modified drive route to the user within the user interface for confirmation; transmit the modified drive route to the local controller of the trailer for execution; and, thereby, derive a drive route for the tractor-trailer that enables the tractor-trailer to meet energy preferences, regulatory requirements (e.g., emissions regulations, noise regulations, weight limit restrictions, speed limits), and prevent topographical roadblocks along the drive route.

### 13.2 In-Route Modifications

Additionally, the computer system can: receive operational data from the trailer during traversal of the drive route; update the estimated completion duration for the drive route; and modify operational mode perimeters assigned to legs proximal the drive route—such as in real-time—based on these operational data. (Alternatively, a local controller in the trailer can autonomously update these operational mode perimeters based on real-time, local, contextual data collected by sensors—integrated into the trailer (and isolated from the trailer)—during traversal of the drive route.)

Thus, the computer system can automatically pre-plan operation of the trailer based on topographical, environmental, speed limit, and regulatory data along the route. During traversal of the drive route, the local controller can then: monitor towing forces applied by a tractor to the trailer (e.g., forces input into a vehicle coupler of the trailer by the tractor) when towed along the drive route; monitor a weight of a load contained in the trailer or a refrigerated trailer along the drive route; and autonomously operate within regimes specified in these target zones—including prioritized torque output assist, prioritized battery recharging, and non-operation—based on the location of the trailer and forces applied by the tractor to the trailer.

Accordingly, the computer system can automatically pre-plan operation of the trailer to account for route topology, regulatory requirements along the route, and/or power requirements of the trailer following completion of the route, etc. Alternatively, the local controller in the trailer can execute this process, such as before or in real-time during traversal of the drive route.

### 12.4 Open-Loop+Closed-Loop Controls

Furthermore, the local controller can: receive a specification for the drive route from the computer system; store the specification for the drive route in local memory; and implement open-loop controls to selectively alternate between operational modes (e.g., torque output assist mode, regenerative braking mode, drag charging mode, disable torque output) during the drive route according to commands specified in or interpreted from the specification.

Alternatively, the local controller can: receive a specification for the drive route from the computer system; store the specification for the drive route in local memory; execute commands specified in or interpreted from the specification; and implement closed-loop controls to intermittently transmit a status of the trailer to the computer system (e.g., once per minute or once per mile). Accordingly, the computer system can update commands in the specification based on the status of the trailer and transmit the updated specification back to the local controller for execution. For example, the local controller can execute commands specified in or interpreted from the specification and transmit a status of the trailer, representing an actual duration for the trailer to traverse the drive route, to the computer system. The computer system can then update commands in the specification to achieve the target state of charge upon arrival of the refrigerated trailer at the destination location and transmit the updated specification back to the local controller for execution.

However, the local controller can alternatively execute Blocks of the method S100 to access a drive route, receive energy preferences for the drive route, estimate energy needs, and selectively alternate between operational modes (e.g., torque output assist mode, regenerative braking mode, drag charging mode, disable torque output) during the drive route to achieve these energy preferences and needs.

### 14. Trailer

Generally, the trailer includes: a trailer chassis; and a set of rails. The left rail and the right rail are coupled to the trailer chassis and run along a longitudinal axis of the trailer, extending parallel to and laterally offset from a longitudinal centerline, to form a channel below the trailer chassis of the trailer.

In one implementation, the trailer includes: a trailer chassis; a left rail coupled to the trailer chassis, extending parallel to and laterally offset from a longitudinal centerline of the trailer, and defining a first array of engagement features distributed along the left rail and longitudinally offset by a pitch distance; and a right rail coupled to the trailer chassis, extending parallel to and laterally offset from the longitudinal centerline of the trailer opposite the left rail, and defining a second array of engagement features distributed along the right rail and longitudinally offset by the pitch distance. In this implementation, the set of rails extend along a length of the trailer and define a channel below the trailer chassis. Alternatively, the set of rails extend along a quantity of the length of the trailer and define a channel below the trailer chassis of the trailer.

Furthermore, the set of engagement features can include a bore, a slot, an aperture, or an indentation distributed along each rail and configured to engage and retain a corresponding latch of a bogie and/or a battery assembly, as further described below. However, each rail can include any other type of engagement feature configured to engage and retain a set of latches of a bogie and/or a battery assembly.

In one implementation, the trailer includes an internal refrigeration system configured to modulate temperatures of an interior of the trailer, such as by cooling or heating the interior of the trailer to preserve goods contained in the refrigerated trailer. In one variation, the trailer includes a hybrid internal refrigeration system. The hybrid internal refrigeration system includes a diesel-powered refrigeration subsystem and an electrical refrigeration subsystem. The diesel-powered refrigeration subsystem is configured to supply energy from liquid fuel (e.g., diesel) to the internal refrigeration system to modulate temperatures of the interior of the trailer. The electrical refrigeration subsystem is configured to receive electrical energy from a battery assembly arranged below the trailer or electrical energy from an external power source (e.g., a shore power connection) and to supply the electrical energy to the internal refrigeration system to modulate temperatures of the interior of the trailer.

In yet another variation, the internal refrigeration system includes an electrical refrigeration subsystem configured to receive electrical energy from the battery assembly arranged below the trailer or from the external power source (e.g., ashore power connection) and to supply the electrical energy to the internal refrigeration system to modulate temperatures of the interior of the trailer.

The trailer chassis supports the driven axle and can include a vehicle coupler to couple the trailer to a tow vehicle—such as a tractor unit, a hybrid tractor, an electric tractor, and/or an internal combustion engine tractor—to form a tractor-trailer (e.g., a semi-truck, a semi, an 18-wheeler). For example, the trailer chassis can include a vehicle coupler arranged on a proximal end of the trailer chassis and configured to interface with a fifth wheel of a tractor, as further described below.

### 14.1 Driven Axle+Motor

The trailer further includes a driven axle supported by an axle housing, suspended from the trailer chassis, and includes a left driven wheel and a right driven wheel. The axle housing further encapsulates a motor mounted to the driven axle and is configured to protect the driven axle and the motor.

The motor is configured to drive the left driven wheel and the right driven wheel and thus, output torque in a torque output assist mode. The motor is further configured to regeneratively brake the left driven wheel and the right driven wheel to slow motion of the trailer in a battery recharging mode.

In one variation, the trailer includes a passive axle, suspended from the trailer chassis, adjacent the driven axle and includes a left passive wheel and a right passive wheel. In this variation, the left passive wheel and the right passive wheel are configured to assist motion of the trailer when the left driven wheel and the right driven wheel are driven by the motor in the torque output assist mode.

### 14.2 Battery Assembly

The trailer can further include a battery assembly configured to transiently install on the trailer over a range of longitudinal positions and electrically couple to the trailer by a power cable or integrated directly with the trailer chassis in order to supply power to the motor.

More specifically, the battery assembly can further supply electrical energy to the motor to output torque to the driven axle in a torque output assist mode and receive electrical energy from the motor to regeneratively brake the driven axle and charge the battery assembly in a battery recharging mode. Further, the battery assembly can include a set of modular batteries configured to engage with each other and fit within a battery frame. The battery frame is configured to fit below a standard trailer chassis of a trailer between the left rail and the right rail and thus, enable a user to quickly and repeatably install the battery assembly or the set of modular batteries below a standard floor of any trailer. The set of modular batteries enables a user to selectively adjust the battery capacity of the battery assembly as a function of a predicted distance traveled by the trailer, a weight distribution of the trailer, and/or a type of the trailer (e.g., a dry van trailer, a refrigerated trailer).

In one implementation, the battery assembly includes a set of latches configured to: transiently engage a subset of engagement features, in the first array of engagement features on the left rail and in the second array of engagement features on the right rail; and to retain the battery assembly below the trailer chassis. In this implementation, each latch in the set of latches can include a solenoid (e.g., an electromechanical solenoid, a pneumatic solenoid), or another electromechanical latch (e.g., an air pressure latch, a mechanical latch) operable in an engaged position and a disengaged position to transiently engage and/or disengage a corresponding engagement feature distributed along the left rail and the right rail of the trailer.

In one example, the battery assembly can include a set of cylindrical modular batteries to connect at a top and a bottom of the battery to engage each other modular battery in the set of cylindrical modular batteries. In this example, a first modular battery in the set of modular batteries can include an adapter configured to electrically couple the battery assembly to the power cable.

However, each modular battery in the battery assembly can define any other shape and electrically couple to the power cable in any other way. Alternatively, the battery assembly can directly connect to the motor without a power cable.

### 14.2 Vehicle Coupler

The trailer can further include a vehicle coupler arranged on a proximal end of the trailer chassis opposite the bogie and is configured to interface with a hitch (e.g., a fifth wheel) of a tow vehicle. The vehicle coupler further includes a set of sensors configured to output a signal representing forces applied to the vehicle coupler by the hitch.

In one implementation, the vehicle coupler includes: a head; a shank; a base; a set of fasteners; a geolocation module; a wireless communications module; and a suite of sensors including force sensors (e.g., a strain gauge, an IMU, a load cell), optical sensors (e.g., a one-dimensional depth sensor, a LIDAR sensor, an RGB camera), and/or inertial sensors (e.g., an IMU, an accelerometer, a gyroscope). The vehicle coupler is further characterized by a unitary steel alloy structure.

In one variation, the vehicle coupler is coupled to the trailer chassis and is configured to transfer vertical loads from the trailer into a hitch of a tow vehicle. In this variation, the set of sensors are configured to: output signals representing forces applied to the vehicle coupler (e.g., via the force sensors); output signals representing inertial conditions of the trailer (e.g., via the inertial sensors); output signals representing a location of the trailer (e.g., via the geolocation module); and transmit these force data, inertial conditions data, weight distribution data, and/or geolocation data to the local controller via the communications module.

In another variation, the vehicle coupler can include a set of force sensors. In this variation, the vehicle coupler can include: a first sensor configured to output signals representing lateral forces applied to the vehicle coupler by the hitch of the tow vehicle; and a second sensor configured to output signals corresponding to longitudinal forces, parallel to a longitudinal axis of the trailer, applied to the vehicle coupler by the hitch of the tow vehicle. Each sensor can then transmit these force data to the local controller.

### 14.4 Other Sensors

In one implementation, the trailer can include additional sensors, such as other force sensors (e.g., a load cell, an IMU), optical sensors (e.g., a one-dimensional depth sensor, a LIDAR sensor, an RGB camera), proximity sensors (e.g., a Hall effect sensor, a conductive sensor, an inductive sensor), inertial sensors (e.g., an IMU, an accelerometer, a gyroscope), a geospatial location sensor (e.g., a GPS sensor); and/or ambient sensors (e.g., a temperature sensor, a hygrometer, an anemometer) coupled to the trailer chassis.

Further, each sensor can generate sensor data (e.g., analog values, digital values) in a sense domain, such as including: a location of the trailer; a speed of the trailer; a state of charge of the battery assembly; an incline angle or a decline angle of the trailer relative a ground surface; an acceleration of the trailer; a weight distribution on the driven axle; and/or a tractor-trailer angle of the trailer. Each sensor can then transmit these sensor data to the local controller.

In one variation, the vehicle coupler can include an inertial measurement unit (e.g., an IMU) configured to output signals representing motion in pitch, roll, and yaw positions of the vehicle coupler, angular velocity of the trailer, and/or orientation of the trailer. The inertial measurement unit can then transmit these signals to the local controller. Based on these signals, the local controller can derive a set of coordinates representing a location of the trailer, such as a latitude coordinate and a longitude coordinate within a map depicting a drive route.

In another variation, the trailer can include: a load cell coupled to the trailer chassis proximal the driven axle and configured to output signals representing tension, compression, pressure, or torque applied to the driven axle and transmit these signals to the local controller.

In yet another variation, the trailer can include an accelerometer coupled to the trailer chassis and arranged on the proximal end of the trailer chassis. The accelerometer is further configured to output signals representing acceleration or speed of the trailer. The accelerometer can then transmit these signals to the local controller.

### 15. Local Controller

The local controller is coupled to sensors of the trailer and executes methods and techniques described below to: record ambient conditions (e.g., via ambient sensors); detect conditions of the trailer (e.g., a speed, an incline angle, a tractor-trailer angle, a location, a state of charge of the battery assembly) along a drive route; record time stamps of the trailer upon entering or exiting legs of the drive route; prioritize torque output assist by selectively triggering the battery assembly to supply electrical energy to the motor to increase and/or reduce torque output to the driven axle in a torque output assist mode; and prioritize regenerative braking by selectively triggering the motor to supply electrical energy to the battery assembly to regeneratively brake the driven axle and charge the battery assembly in a battery recharging mode.

Further, the local controller is configured to transmit non-optical data from sensors coupled to the trailer (e.g., battery state of charge data, geospatial location data, speed data, fuel level data) to the computer system to monitor energy allocation of the tractor-trailer along the drive route. The computer system can manipulate these data to extract metrics and insights, update the drive route in “real-time,” and generate commands for the local controller to execute according to the updated drive route as further described below.

### 15.5 Computer System

The computer system, such as a remote server, can receive a drive route for a tractor-trailer between a start location and a destination location via a user interface and segment the drive route into a set of legs. The computer system can further derive and assign a target zone indicating an operational mode, such as a battery recharging and/or a torque output assist mode—to each leg in order to reduce emissions and increase fuel efficiency of the tractor-trailer according to energy preferences defined by the user. Additionally, the computer system can monitor the drive route and execute actions (e.g., generate commands for the local controller) throughout the drive route.

More specifically, the computer system can: segment a drive route into a set of legs between the start location and the destination location; assign a trailer type and a battery capacity of a battery assembly associated with the trailer type to the drive route; and estimate a time duration for completion of the drive route by the tractor-trailer. The computer system can then transmit the modified drive route, the battery capacity, the trailer type, and the estimated time duration to the local controller of the trailer.

Additionally, the computer system can receive non-optical data from the local controller during traversal of the drive route or an in-process drive route. The computer system can then manipulate these data to update the estimated time interval until completion of the drive route; to increase or reduce an operational mode perimeter proximal the drive route; to transmit these updated operational mode perimeters to the local controller; and/or to extract metrics and insights from the drive route.

### 16. Setup Period

Generally, during a setup period, the computer system can receive a drive route defining a start location, intermediate locations (e.g., stops, delivery locations), and a destination location entered by a user via a user interface. Additionally, the computer system can receive a set of target conditions (or “energy preferences”) for the drive route and a specification for the tractor-trailer from the user interface.

More specifically, the computer system can interface with a user interface to receive a drive route for a refrigerated tractor-trailer vehicle combination between a start location and a destination location. The computer system can further receive a set of energy preferences defined by the user, such as a threshold state of charge of the battery assembly, maximize fuel efficiency of the tractor-trailer, minimize intermediate locations (e.g., stops) along the drive route, preservation of goods during the drive route and for extended time periods to store these goods at the destination location, and/or compliance with regulatory requirements, such as emissions or noise regulations. The computer system can receive a specification for the tractor-trailer specifying: a vehicle combination; a gross weight of the vehicle combination; a tow vehicle type; a condition of components of the tow vehicle or the refrigerated trailer (e.g., tire wear, oil change status); a set of dimensions of the tow vehicle; a refrigerated trailer type; and a battery capacity of a battery module of the tow vehicle entered by the user.

### 16.1 Drive Route+Specification for Tractor-Trailer

Block S110 of the method S100 recites accessing a drive route for the refrigerated trailer between a current location and a destination location. Generally, in Block S110, the computer system can receive a drive route for a tractor-trailer defining a start location and a destination location from a user via the user interface.

In one implementation, the user may access the user interface to define a set of coordinates (e.g., a latitude coordinate and a longitude coordinate) for the start location and the destination location within a map depicting a geographical region between the start location and the destination location. Further, the user can define the start location as a start latitude and longitude within a map depicting a geographical region between the start location and the destination location and define the destination location as a delivery latitude and longitude within the map. For example, an administrator may interface with the user interface to enter a drive route for a tractor-trailer to transport cargo within a geographic region between a start location, such as a cargo port, and a destination location, such as a customer warehouse. The administrator may define: a start location of the cargo port as (33.7292, −118.2620) within a map depicting the geographic region and define the destination location as (33.065, −114.997) within the map.

Furthermore, the user can enter a specification of a tow vehicle for the drive route—defining a vehicle combination, a gross weight of the vehicle combination, a tow vehicle type, a refrigerated trailer vehicle type, a height of the tow vehicle, a length of the tow vehicle, a width of the tow vehicle, a capacity of a fuel tank of the tow vehicle, an estimated cost of fuel, and/or a capacity of a battery module of the tow vehicle—via the user interface. For example, the user may submit a specification of the tow vehicle including: a tractor-trailer vehicle combination; a gross weight of 80,000 pounds for the tractor-trailer; an internal combustion engine tow vehicle type; and a capacity of 120 gallons for the fuel tank of the tow vehicle.

Thus, a user may interface with the computer system via a user interface to submit a drive route for a tractor-trailer transporting cargo over a geographic region between a start location and a destination location and may define latitude and longitude coordinates for the start location and the destination location.

### 16.2 Energy Preferences

Block S160 of the method S100 recites receiving a set of energy preferences for the drive route. Generally, in Block S160, the computer system can present a menu of predefined energy preferences for the drive route to the user within the user interface.

In one implementation, the user may select a set of energy preferences for the drive route, such as a threshold state of charge of the battery assembly, maximize fuel efficiency of the tractor-trailer, minimize intermediate locations (e.g., stops) along the drive route, preservation of goods during the drive route by the electrical subsystem or by the diesel-powered refrigeration subsystem, preservation of goods for extended time periods (e.g., storage durations) at the destination location by the electrical subsystem and/or the diesel-powered electrical subsystem, a speed threshold, and/or compliance with regulatory requirements (e.g., emissions or noise regulations).

In one variation, the computer system can render a set of data input fields within a user interface (e.g., a graphic user interface, a user portal) in order to record energy preferences for the drive route. Further, the computer system can render one or more slider bars (or any other adjustable user-interface element) within the user interface to enable the user to indicate an importance or priority of each energy preference.

In one example, the computer system: renders a first slider bar in a user portal representing a first energy preference, such as fuel efficiency of the tow vehicle; renders a second slider bar in the user portal representing a second energy preference, such as preservation of goods; interprets the first energy preference as maximum fuel efficiency of the tow vehicle based on a first change in a position of the first slider bar; and interprets the second energy preference as preservation of goods for the drive route and a storage duration by the electrical refrigeration subsystem.

In another example, the computer system: renders a slider bar, in a set of sliders, in the user interface representing a first energy preference such as preservation of the set of goods; and, in response to a change in a position of the slider bar, interprets the first energy preference as preservation of the set of goods for the time duration.

### 16.2.1 Historical Energy Preferences

Additionally or alternatively, the computer system can access historical energy preferences selected by the user or by similar users for the same or similar drive routes. The computer system can prompt the user to answer survey questions or select a set of energy preferences from a menu rendered in the user interface to indicate a preferred threshold state of charge of the battery assembly, a preference to maximize fuel efficiency of the tractor-trailer, a preference to minimize intermediate locations (e.g., stops) along the drive route, a preference to preserve goods during the drive route by the electrical refrigeration subsystem or by the diesel-powered refrigeration subsystem, a preference to preserve goods for extended time periods (e.g., a storage duration) at the destination location by the electrical refrigeration subsystem, a preferred threshold speed, and/or a preference to comply with regulatory requirements (eg., emissions or noise regulations).

For example, the user may select a set of energy preferences for the drive route including: a speed threshold for the drive route, such as 70 miles-per-hour, and a reserve state of charge of the battery assembly of the trailer, such as 25%, upon arrival of the trailer at the destination location.

Therefore, the user may select a set of energy preferences of interest to the user for the drive route after submitting the drive route. Additionally, the user may further select prioritization of goods by the electrical refrigeration subsystem and/or by the diesel-powered refrigeration subsystem to reduce loss of these goods during the drive route or during storage at the destination location. The computer system can then transmit the drive route, the specification, and the set of energy preferences to the local controller for execution of the drive route.

### 17. Refrigerated Trailer

Block S112 of the method S100 recites accessing a target temperature range for an interior of the refrigerated trailer containing a set of goods. Generally, in Block S112, the computer system can receive a specification for the tractor-trailer specifying presence of goods contained in the refrigerated trailer, a type of goods, a quantity of goods, a location of the goods relative to the interior of the trailer (e.g., a frozen goods compartment), a target temperature range for these goods during the drive route, a storage duration to maintain this target temperature range upon arrival of the refrigerated trailer at the destination location, and/or a delivery time window for the goods.

More specifically, the computer system can: access the drive route specifying the set of latitude and longitude coordinates; receive the set of energy preferences; receive the specification for the tow vehicle; and calculate a target state of charge (e.g., a reserve or a minimum quantity) of the battery assembly of the trailer to supply electrical energy to a refrigeration system of the refrigerated trailer to modulate temperatures of the interior of the trailer during traversal of the drive route and for storage durations after completion of the drive route. The local controller can then selectively alternate between operational modes during traversal of the drive route by a tow vehicle hauling the refrigerated trailer to achieve the set of energy preferences and the reserve state of charge of the battery assembly upon arrival of the refrigerated trailer at the destination location.

For example, during the setup period, a fleet manager may interface with the user interface to upload a drive route for a refrigerated tractor-trailer vehicle combination to transport goods, such as bananas over a geographic region. The fleet manager may then define a set of (e.g., two) latitude and longitude coordinates of a start location, such as a cargo port and a destination location, such as a customer warehouse. The fleet manager may define: a start location of the cargo port as (33.7292, −118.2620) within a map depicting the geographic region and define the destination location as (33.065, −114.997) within the map. The fleet manager may then select a set of energy preferences, such as a speed threshold of 60 miles-per-hour and a maximum fuel efficiency for the drive route.

The user may also upload a specification of the tow vehicle including a refrigerated tractor-trailer vehicle combination, a gross weight of 80,000 pounds for the refrigerated tractor-trailer vehicle combination, an electric tow vehicle type, and a battery capacity of 350 kilowatt-hours for the battery module of the tow vehicle. The user may further define a target temperature range, such as 57 degrees Fahrenheit for the perishable bananas contained in the refrigerated trailer for the drive route and a duration to maintain this target temperature range, such as 30 kilowatt-hours.

17.1 Prediction of Storage Duration for goods

Block S120 of the method S100 recites predicting a time duration between arrival of the refrigerated trailer at the destination location and unloading of the set of goods. Generally, in Block S120, the computer system can retrieve the storage duration to maintain the target temperature range of goods, defined by the user or predict a storage duration for these goods at the destination location.

In one implementation, the computer system can retrieve the storage duration to maintain the target temperature range of goods from the user interface. Alternatively, the computer system can predict the storage duration based on data from the cargo specification for the refrigerated trailer. Further, a user may upload a cargo specification for the refrigerated trailer defining: a delivery window for unloading the set of goods; a quantity of the set of goods contained within the interior of the refrigerated trailer; and the target temperature range for the interior of the refrigerated trailer. The computer system can then predict the storage duration between arrival of the refrigerated trailer at the destination location and unloading of the set of goods proportional to the quantity of the set of goods and/or the delivery window for unloading the set of goods.

For example, the user may upload a cargo specification for the refrigerated trailer defining: a delivery window, such as between 8 AM and 11 AM, for unloading of perishable bananas at a destination location, such as a grocery store; a quantity of the perishable bananas, such as twenty pallets; and a target temperature range for the interior of the refrigerated trailer, such as 57 degrees Fahrenheit and 58 degrees Fahrenheit. Accordingly, the computer system can predict a storage duration, such as one hour, between arrival of the refrigerated trailer at the grocery store and unloading of the bananas based on the quantity of bananas. Alternatively, the computer system can predict a storage duration, such as three hours, between arrival of the refrigerated trailer at the grocery store and unloading of the bananas corresponding to the delivery window.

In one variation, the computer system can automatically predict a storage duration for these goods at the destination location based on historical storage durations associated with similar goods, similar drive routes, or similar destination locations. For example, the computer system can access historical storage durations associated with bananas, associated with grocery stores, or associated with drive routes between a cargo port and a grocery store. The computer system can then calculate an average of these storage durations and identify the average storage duration as the storage duration between arrival of the refrigerated trailer at the grocery store and unloading of the set of bananas.

Therefore, the computer system can retrieve a storage duration from a cargo specification uploaded by the user via the user interface or dynamically predict a storage duration between arrival of the refrigerated trailer at the destination location and unloading of the set of goods for the drive route according to historical storage durations associated with similar goods, similar drive routes, or similar destination locations.

### 17.2 Electrical Energy

Block S130 recites estimating a quantity of electrical energy to maintain temperatures of the interior refrigerated trailer within the target temperature range for the time duration. Generally, in Block S130, the computer system can estimate a quantity or an amount of electrical energy necessary to increase or decrease temperatures of the interior of the refrigerated trailer within the target temperature range for the storage duration.

In one implementation, the computer system can estimate the quantity of electrical energy to maintain temperatures of the interior of the refrigerated trailer within the target temperature range based on weather forecasts for the destination location. The computer system can access a weather database and extract a set of weather forecasts at the destination location from the weather database. Alternatively, the computer system can predict a set of weather forecasts for the destination location based on historical weather conditions for the destination location within time windows corresponding to the delivery time window, as defined by the user. Based on the historical weather conditions, the computer system can predict weather forecasts within the delivery time window for the destination location. The computer system can calculate a quantity of electrical energy necessary to maintain temperatures of the interior of the refrigerated trailer within the target temperature range for the target duration as a function of these weather forecasts.

For example, the computer system can retrieve historical weather conditions for a grocery store within time windows analogous to the delivery time window, such as between 8 AM and 11 AM. The computer system can then predict an ambient temperature of air and ambient humidity forecast within the delivery time window for the destination location according to these historical weather conditions. The computer system can then calculate a quantity of electrical energy necessary to maintain temperatures of the interior of the refrigerated trailer within the target temperature range for the storage duration inversely proportional to the ambient temperature of air forecast and the ambient humidity of air forecast.

Accordingly, the computer system can: increase the quantity of electrical energy for ambient temperatures of air less than a target temperature range specified by a manufacturer for the battery assembly; and decrease the quantity of electrical energy for ambient temperatures of air greater than the target temperature range. Thus, the computer system can dynamically predict a quantity of electrical energy necessary to maintain temperatures of the interior of the refrigerated trailer within the target temperature range for the storage duration in order to achieve a target state of charge of the battery assembly to supply this electrical energy, as further described below.

Furthermore, the computer system can track the quantity of electrical energy to maintain temperatures of the interior of the refrigerated trailer within the target temperature range over time and predict a set of thermal characteristics (e.g., insulation characteristics of the internal refrigeration system) of the refrigerated trailer. Based on these thermal characteristics, the computer system can: interpret a loss of electrical energy within the internal refrigeration system, such as the insulation of the interior of the refrigerated trailer; and increase the quantity of electrical energy proportional to the loss of electrical energy for subsequent drive routes traversed by this refrigerated trailer. Because the insulation or other structural components of the refrigerated trailer can deteriorate over time and result in loss of electrical energy within the interior of the refrigerated trailer, the computer system can increase the quantity of electrical energy to maintain temperatures of the interior of the trailer within the target temperature range to offset the loss of electrical energy.

### 17.3 Reserve State of Charge of Battery Assembly

Block S140 of the method S100 recites calculating a target state of charge of a battery assembly of the refrigerated trailer to supply the quantity of electrical energy to a refrigeration system to modulate temperatures of the interior of the refrigerated trailer. Generally, in Block S140, the computer system can calculate a reserve or a minimum state of charge of the battery assembly of the refrigerated trailer necessary to supply the electrical energy to cool or to heat the interior to preserve the goods in the refrigerated trailer during the drive route and during the storage duration.

In one implementation, the computer system calculates a reserve state of charge of the battery assembly of the refrigerated trailer—such as a percentage of available charge in the battery assembly relative to a capacity of the battery assembly—necessary to supply the quantity of electrical energy to the refrigeration system to modulate temperatures of the interior of the refrigerated trailer. Because the reserve state of charge of the battery assembly is associated with a remaining quantity of electrical energy available in the battery assembly, the computer system can interpret a state of charge of the battery assembly associated with the quantity of electrical energy as the reserve state of charge of the battery assembly. For example, the computer system can calculate a target state of charge (e.g., 15%) of the battery assembly of the trailer necessary to supply the quantity of electrical energy to the refrigeration system of the refrigerated trailer for the storage duration at the destination location.

Accordingly, the computer system can cooperate with the local controller of the trailer to selectively adjust the operational mode to achieve the set of energy preferences and the reserve state of charge of the battery assembly upon arrival of the refrigerated trailer at the destination location.

### 18. In-Route Operational Modes

Block S150 of the method S100 recites, during traversal of the drive route by the refrigerated trailer coupled to a tow vehicle: selectively outputting torque to the driven axle to increase fuel efficiency of the tow vehicle; and selectively regeneratively braking the driven axle to recharge the battery assembly and to achieve the target state of charge of the battery assembly upon arrival of the refrigerated trailer at the destination location. Generally, in Block S150, the local controller of the trailer can: trigger the motor to selectively output torque or regenerative braking torque to the driven axle to achieve the set of energy preferences for the drive route and to achieve the reserve state of charge of the battery assembly upon arrival of the refrigerated trailer at the destination location.

More specifically, during traversal of the drive route by the tow vehicle hauling the refrigerated trailer, the local controller can access geospatial location data, speed data, fuel consumption data, state of charge of the battery assembly data, and energy consumption data via sensors coupled to the trailer chassis and autonomously prioritize torque output assist by the motor to the driven axle, prioritize regenerative braking to charge the battery assembly, or disable torque output to reduce power consumption by the trailer according to these data.

Furthermore, in a torque output assist mode, the local controller can trigger the battery assembly to supply electrical energy to the motor of the refrigerated trailer to output torque to the driven axle and to achieve the set of energy preferences. In a regenerative braking mode, the local controller can trigger the motor to supply electrical energy to the battery assembly to regeneratively brake the driven axle and thus, charge the battery assembly and achieve the reserve state of charge of the battery assembly upon arrival of the refrigerated trailer at the destination location.

### 18.1 Energy Consumption

In one variation, the computer system calculates a total distance of the drive route between the start location and the destination location. During traversal of the drive route, the local controller: monitors an energy consumption rate of the refrigerated trailer (e.g., kwh); and predicts a distance traversable by the refrigerated trailer according to a battery capacity of the battery assembly and the energy consumption rate. Responsive to the distance falling below the total distance of the drive route, the local controller can prioritize regenerative braking by selectively triggering the motor to increase regenerative braking torque to the driven axle to recharge the battery assembly in order to achieve the reserve state of charge of the battery assembly upon arrival of the refrigerated trailer at the destination location.

For example, the computer system can: calculate a total distance of the drive route between the start location and the destination location, such as 400 miles; and access a battery capacity, such as 280 kilowatt-hours of the battery assembly of the refrigerated trailer. During traversal of the drive route, the local controller can: estimate an energy consumption rate of the refrigerated trailer; predict a distance traversable by the refrigerated trailer based on the battery capacity and the energy consumption of the refrigerated trailer, such as 300 miles; and, in response to the distance traversable by the refrigerated trailer (e.g., 300 miles) falling below the total distance of the drive route (e.g., 400 miles), prioritize regenerative braking by triggering the motor to output regenerative braking torque to the driven axle in order to recharge the battery assembly and to drive the battery assembly to a state of charge greater than the target state of charge.

Alternatively, responsive to the distance exceeding the total distance of the drive route, the local controller can detect a difference between the distance and the total distance and derive a quantity of excess electrical energy available at the battery assembly (e.g., stored in the battery assembly) from the difference. The local controller can then automatically prioritize torque output assist by selectively triggering the battery assembly to supply electrical energy to the motor to increase and/or reduce torque output to the driven axle in the torque output assist mode until the excess electrical energy is depleted. Thus, the local controller can identify an excess electrical energy stored in the battery assembly and allocate this excess electrical energy for torque output assist in order to increase the fuel efficiency of the tow vehicle hauling the refrigerated trailer.

Therefore, the computer system can cooperate with the local controller to monitor energy consumption of the refrigerated trailer traversing the drive route in order to prioritize torque output assist or regenerative braking. The local controller can then: selectively trigger the motor to regeneratively brake the drive axle to ensure that the state of charge of the battery assembly matches the reserve state of charge upon arrival of the refrigerated trailer at the destination location; or selectively trigger the battery assembly to supply an excess electrical energy to the motor to output torque to the drive axle to increase fuel efficiency of the tow vehicle.

### 18.2 Fuel Consumption

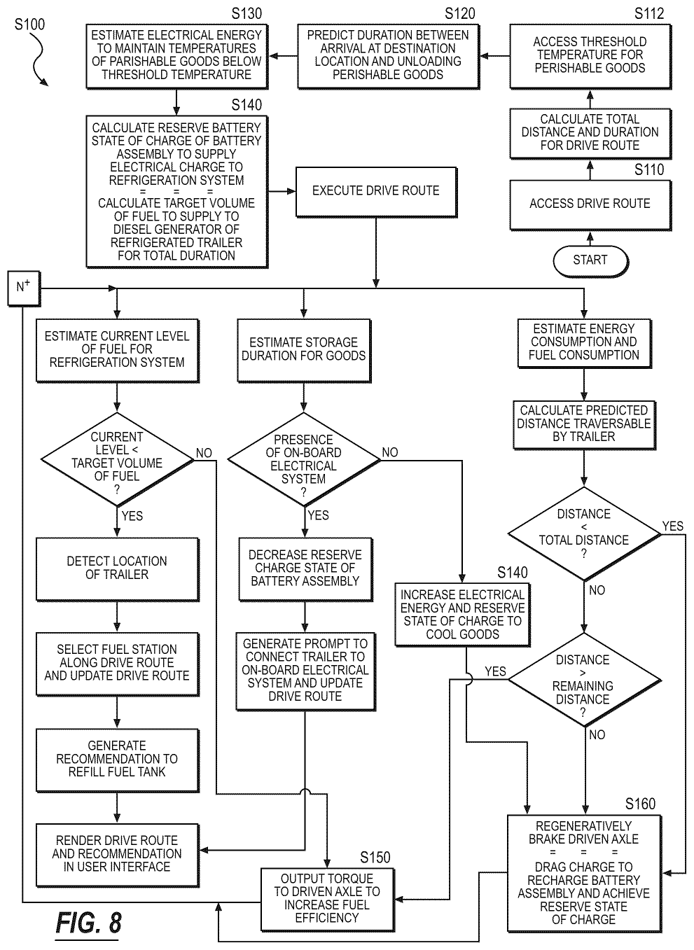

In one implementation, during traversal of the drive route, the local controller detects a fuel level in a fuel tank of the tow vehicle hauling the refrigerated trailer via a fuel level sensor (or data from a data output port on the tow vehicle) and monitors a fuel consumption rate by the tow vehicle. The local controller further predicts a distance traversable by the refrigerated trailer according to the fuel consumption rate and the current fuel level in the fuel tank of the tow vehicle. Responsive to the distance exceeding a remaining distance of the drive route, the local controller prioritizes torque output to assist motion of the tow vehicle and increases fuel efficiency of the tow vehicle, as shown in FIG. 8.

For example, the local controller can: track a fuel consumption rate of the tow vehicle; detect a current location of the refrigerated trailer via a global positioning receiver; calculate a remaining distance of the drive route between the current location of the refrigerated trailer and the destination location; detect a fuel level in a fuel tank coupled to the internal refrigeration system of the refrigerated trailer; calculate an operational distance traversable by the refrigerated trailer based on the fuel level and the fuel consumption rate; and, in response to the predicted distance exceeding the remaining distance of the drive route, trigger the battery assembly to supply electrical energy to the motor to output torque to the driven axle for the remaining distance of the drive route in order to increase fuel efficiency of the tow vehicle.

Therefore, because a stop to refill a fuel tank of the tow vehicle along the drive route requires additional electrical energy to modulate temperatures of the interior of the refrigerated system and may extend the duration of the drive route (i.e., delay the delivery window), the local controller can prioritize torque output for the remaining distance of the drive route to avoid a stop to refill the fuel tank of the tow vehicle.

### 18.3 Allocation of Excess Electrical Energy

Generally, the local controller can recalculate the reserve state of charge of the battery assembly on an interval (e.g., once per 50 miles traversed, once per 10 miles traversed) during the drive route. The local controller can then: monitor a current state of charge of the battery assembly; detect differences between the current state of charge and the reserve state of charge; and allocate an excess electrical energy, corresponding to these differences, for torque output to further increase the fuel efficiency of the tow vehicle.

In one implementation, the local controller: segments the drive route into a set of legs; recalculates the target state of charge of the battery assembly for a leg of the drive route; and detects a state of charge of the battery assembly during this leg. In response to the state of charge exceeding the target state of charge of the battery assembly, the local controller further: detects a difference between the state of charge and the target state of charge of the battery assembly; calculates an excess electrical energy, stored in the battery assembly, based on the difference between the state of charge and the target state of charge of the battery assembly; and allocates the excess electrical energy, stored in the battery assembly, for torque output by the refrigerated trailer to a later segment in the set of segments of the drive route associated with a positive elevation profile.

In one variation, the local controller can access topography data representing elevation profiles from a topography database and allocate the excess electrical energy to a leg of the drive route associated with a positive elevation profile (e.g., a positive slope, an incline angle) that indicates uphill motion for the refrigerated trailer. For example, during traversal of the drive route, the local controller can: access a set of topography data for the drive route from a road topography database; identify a first elevation profile associated with a second segment in the set of segments from the set of topography data; and, in response to the first elevation profile representing a negative slope for the second segment, identify a second elevation profile associated with a third segment in the set of segments. In response to the second elevation profile representing a positive slope for the third segment, the local controller can allocate the excess electrical energy for torque output, by the refrigerated trailer, to the third segment in the set of segments along the drive route.

Alternatively, in response to identifying an elevation profile representing a negative slope for the second segment, the local controller can assign regenerative braking to this segment. For example, during traversal of this segment of the drive route, the local controller can trigger the motor to regeneratively brake the battery assembly to recharge the battery for this segment. During traversal of the third segment, the local controller can allocate the excess electrical energy—stored in the battery and generated from regeneratively braking the driven axle—for torque output to the third segment along the drive route. Thus, the local controller can manage momentum of the refrigerated trailer along the drive route by regeneratively braking the driven axle during a segment of the drive route characterized by a negative slope and allocating excess energy from this segment to a subsequent segment of the drive route characterized by a positive slope.

Therefore, the local controller can monitor a current state of charge of the battery assembly throughout the drive route relative to the reserve state of charge of the battery assembly. The local controller can then interpret excess electrical energy stored in the battery assembly based on positive differences between the current state of charge and the target state of charge and allocate this excess electrical energy for uphill motion by the refrigerated trailer in order to maximize the fuel efficiency of the tow vehicle hauling the refrigerated trailer.

### 18.4 Hybrid Refrigerated Trailer: Refrigeration Subsystems

In one implementation, the refrigerated trailer includes a a diesel-powered refrigeration subsystem that supplies energy to an internal refrigeration system of the refrigerated trailer, and an electrical refrigeration subsystem that supplies energy from the battery assembly arranged on the trailer to the internal refrigeration system of the refrigerated trailer. The diesel-powered refrigeration subsystem supplies energy to the internal refrigeration system of the refrigerated trailer to modulate temperatures of the interior of the trailer during the drive route. Upon arrival of the refrigerated trailer at the destination location, the local controller triggers the battery assembly to supply stored electrical energy to the electrical refrigeration subsystem. Accordingly, the electrical refrigeration subsystem supplies the electrical energy to the internal refrigeration system of the refrigerated trailer to modulate temperatures of the interior of the trailer for the time duration (e.g., storage duration).

In one variation, the local controller can implement methods and techniques described above to: predict a total duration for traversal of the drive route by the refrigerated trailer; allocate a quantity of energy supplied by the diesel-powered refrigeration subsystem to the internal refrigeration system of the refrigerated trailer for the total duration; and allocate a second quantity of electrical energy for the battery assembly to supply through the electrical refrigeration subsystem to the internal refrigeration system of the refrigerated trailer for the time duration (e.g., between arrival of the refrigerated trailer at the destination location and unloading of goods). The local controller can then: trigger the diesel-powered refrigeration subsystem to supply the quantity of energy to the internal refrigeration system to modulate temperatures of the interior of the refrigerated trailer during traversal of the drive route; and trigger the battery assembly to direct the second quantity of electrical energy to the internal refrigeration subsystem to supply to the internal refrigeration system upon arrival of the refrigerated trailer at the destination location.

Therefore, the computer system and the local controller can cooperate to allocate energy from the diesel-powered refrigeration subsystem and/or from the electrical subsystem to modulate temperatures of the interior of the refrigerated trailer during traversal of the drive route in addition to the reserve state of charge of the battery assembly upon arrival of the refrigerated trailer at the destination location.

### 18.5 Regulatory Requirements

In one implementation, the computer system can access regulatory requirements data (e.g., emissions limits, regulatory restrictions, speed limit restrictions, idling times, congestion fees, or noise ordinances) from a regulatory database(s). The computer system can then identify regulatory requirements associated with intermediate locations or destination locations of the drive route and the local controller can selectively trigger the motor to output torque to or regenerative brake the driven axle. Additionally, the local controller can selectively trigger the battery assembly to direct electrical energy to the electrical refrigeration subsystem to supply to the internal refrigeration system of the refrigerated trailer to comply with these regulatory requirements.

In one variation, the computer system can: identify an emissions regulation zone intersecting the drive route; access a emissions threshold for the tow vehicle, hauling the trailer, within the emissions regulation zone (e.g., a quantity of nitrogen oxides emitted by a tow vehicle); estimate a total energy to traverse a leg of the drive route within the emissions regulation zone; calculate a maximum energy from liquid fuel, available to the tow vehicle within the emissions regulation zone, based on the emissions threshold; and calculate a minimum electrical energy stored in the battery assembly, upon entering the emissions regulation zone, based on a difference between the total energy and the maximum energy from liquid fuel. The local controller can then: detect a current location of the refrigerated trailer; and, in response to the current location intersecting the emissions regulation zone, triggering the battery assembly to supply the minimum electrical energy to the motor to output torque to the driven axle and to comply with the emissions threshold during traversal of the emissions regulation zone.

Therefore, the computer system can cooperate with the local controller to detect low- or no-emissions zones along the drive route and selectively increase torque output to the driven axle in these low-emissions or no-emissions zones in order to reduce or prevent emissions (e.g., nitrogen oxides, particulate matter) from the tow vehicle. Additionally, the computer system can calculate a minimum quantity of electrical energy, stored at the battery assembly, to maintain emissions by the tow vehicle below the emissions threshold during traversal of these emissions zones.

In another variation, the computer system can: identify an emissions regulation zone intersecting the drive route; access an emissions threshold for the refrigeration system of the refrigerated trailer within the emissions regulation zone (e.g., a zero emissions limit or a null quantity emissions limit); estimate a total energy required to operate the refrigeration system of the refrigerated trailer during the leg of the drive route within the emissions regulation zone; calculate a maximum energy from liquid fuel, available to a diesel-powered subsystem, within the refrigeration system, tow vehicle within the emissions regulation zone, based on the emissions threshold (e.g, two gallons of liquid fuel or zero gallons of liquid fuel); and calculate a minimum electrical energy, stored in the battery assembly, to supply to an electrical refrigeration subsystem, within the refrigeration system, upon entering the emissions regulation zone based on a difference between the total energy and the maximum energy from liquid fuel. During traversal of the emissions regulation zone by the refrigerated trailer, the local controller can: detect a current location of the refrigerated trailer; and, in response to the current location intersecting the emissions regulation zone, trigger the battery assembly to supply the minimum electrical energy to the electrical refrigeration subsystem to power the internal refrigeration system and to comply with the emissions threshold during traversal of the emissions regulation zone.

Therefore, the computer system can cooperate with the local controller in low- or no-emissions zones along the drive route to selectively supply electrical energy to the electrical refrigeration subsystem in order to power the internal refrigeration system of the refrigerated trailer and to prevent emissions from the diesel-powered subsystem of the refrigerated trailer in these emissions zones. Additionally, the local controller can alternate power to the internal refrigeration system from the diesel-powered refrigeration subsystem or from the electrical refrigeration system to comply with emissions threshold specified for these emissions regulation zones.

### 19. Shore Power+Electrical Grid

In one implementation, the computer system can interface with the user interface to receive a drive route for a refrigerated tractor-trailer vehicle combination between a start location, a set of intermediate locations, and a destination location entered by the user. The computer system can further access a storage duration—such as extended periods of time or overnight—for the set of goods contained in the refrigerated trailer at an intermediate location from the user interface.

Furthermore, the user may define a pull-down condition for the refrigerated trailer specifying reduction of the ambient temperature of goods, contained in the refrigerated trailer, to a temperature within the target temperature range for the drive route and presence or absence of an on-board electrical system (e.g., shore power or electrical grid) at each intermediate location along the drive route. The computer system can then calculate the reserve state of charge of the battery assembly according to presence or absence of an on-board electrical system at each intermediate location and the pull-down condition for the refrigerated trailer.

For example, the computer system can implement methods and techniques described above to calculate a reserve state of charge, such as 15%, of the battery assembly to supply electrical energy through the electrical refrigeration subsystem to power the internal refrigeration system of the refrigerated trailer. Then, in response to identifying presence of shore power at each intermediate location, the local controller can: decrease the reserve state of charge of the battery assembly to 10% for the drive route; generate a prompt for a user (e.g., an operator or a driver) to manually connect an on-board electrical system (e.g., shore power or electric vehicle supply equipment) to an electrical port arranged on the refrigerated trailer; assign the prompt to the intermediate location within the drive route; and present the drive route to the user within the user interface. Thus, the battery assembly and the on-board electrical system can cooperate to supply electrical energy through the electrical refrigeration subsystem to modulate temperatures of the interior of the refrigerated trailer at the intermediate location and thus, achieve the reserve state of charge of the battery assembly upon arrival of the refrigerated trailer at the destination location.

In one variation, the trailer can include an on-board inverter and the computer system can generate a notification prompting a user (e.g., an operator or a driver) to manually connect an electrical port of the trailer to the shore power to supply electrical energy to the electrical refrigeration subsystem for each intermediate location; and annotate each intermediate location within the drive route with this notification.

In another variation, the computer system can access an overnight storage duration for the refrigerated trailer at an intermediate location from the drive route. In response to identifying absence of an on-board electrical system at this intermediate location, the computer system can estimate electrical energy to maintain temperatures of the interior of the refrigerated trailer within the target temperature range for the storage duration; and calculate a new reserve state of charge of the battery assembly, greater than the previous reserve state of charge, to supply the quantities of this electrical energy to the electrical refrigeration subsystem to modulate temperatures of the interior of the refrigerated trailer overnight at the intermediate location. During traversal of the drive route, the local controller can selectively output regenerative braking torque to the driven axle: to recharge the battery assembly; to achieve the second target state of charge of the battery assembly upon arrival of the refrigerated trailer at the intermediate location; and to achieve the target state of charge of the battery assembly upon arrival of the refrigerated trailer at the destination location.

Alternatively, in response to identifying absence of the on-board electrical system at the intermediate location on the drive route, and in response to detecting presence of the diesel-powered refrigeration subsystem, the local controller can estimate a quantity energy for the diesel-powered refrigeration subsystem to direct to the refrigeration system to maintain temperatures of the interior of the refrigerated trailer within the target temperature range for the storage duration. During traversal of the drive route, the local controller can: detect a current location of the trailer; and, in response to the current location corresponding to (e.g., matching) the intermediate location, trigger the diesel-powered subsystem to convert the quantity of energy to electrical energy to power the internal refrigeration system and to modulate temperatures of the interior of the refrigerated trailer for the storage duration.

Therefore, the computer system can automatically decrease or increase the reserve state of charge of the battery assembly according to presence or absence of on-board electrical systems at each intermediate location along the drive route and thus, reduce fuel consumption and idling time of the tow vehicle at the destination location. Additionally, the local controller can allocate quantities of energy (e.g., quantities of energy from liquid fuel or quantities of electrical energy from the battery assembly) to the diesel-powered refrigeration subsystem or the electrical refrigeration subsystem to power the internal refrigeration system and thereby, modulate temperatures of the interior of the trailer during extended durations at intermediate locations of the drive route.

### 19.1 Prioritization of Electrical Energy

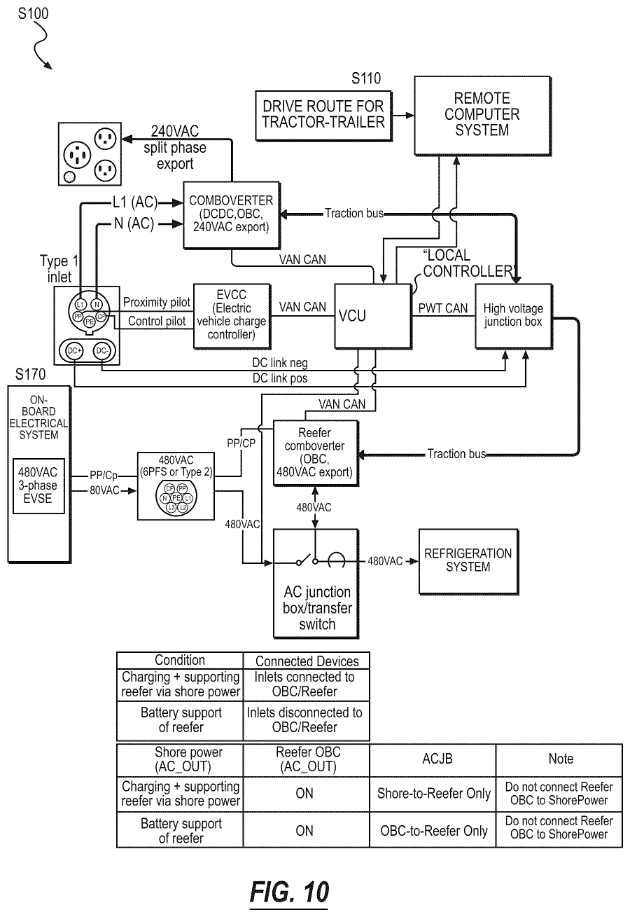

In one variation, the trailer can include an alternating current junction box (e.g., a three-pole double-throw relay junction box) configured to supply electrical energy to the battery assembly of the refrigerated trailer and to the refrigeration system of the refrigerated trailer. While the refrigerated trailer is docked, the local controller can selectively arbitrate between electrical energy sources (or “available power sources”) for the refrigerated trailer by directing electrical energy from an on-board electrical system, such as a shore power supply or an electrical grid, at an intermediate location through the junction box of the trailer to the electrical refrigeration subsystem to maintain temperatures of the interior of the refrigerated trailer within the target temperature range for goods, as shown in FIG. 10.

For example, the local controller can: detect a quantity of electrical energy representing available power from the shore power supply at the intermediate location; detect an energy consumption of the electrical refrigeration subsystem; characterize a difference between the quantity of electrical energy representing available power from the shore power supply and the energy consumption of the electrical refrigeration subsystem; and calculate a second quantity of electrical energy based on the difference between the first quantity of electrical energy and the energy consumption of the electrical refrigeration subsystem; and direct the second quantity of electrical energy to the electrical refrigeration subsystem of the refrigerated trailer to prioritize cooling of the interior of the refrigerated trailer. The local controller can then monitor the energy consumption of the electrical refrigeration subsystem and available power from the shore power supply over a future time period and selectively direct a third quantity of electrical energy to the battery assembly of the trailer to charge the battery assembly as the energy consumption of the electrical refrigeration subsystem adjusts during this time period.

In another variation, while the refrigerated trailer is docked, the local controller can: detect a weight of a load, contained in the trailer, on the driven axle based on a signal received from a load cell coupled to the trailer proximal the driven axle; and transmit the weight of the trailer on the driven axle to the computer system. The computer system can then increase the reserve state of charge of the battery assembly responsive to the weight of the load exceeding a threshold weight and update the drive route in real-time. Alternatively, the computer system can decrease the reserve state of charge of the battery assembly responsive to the weight of the load falling below the threshold weight and update the drive route in real-time.

Therefore, while the refrigerated trailer is docked, the local controller can direct electrical energy to the battery assembly of the trailer and/or to the electrical refrigeration subsystem of the refrigerated trailer in order to ensure a capacity of the battery assembly to maintain a target temperature range of goods following completion of the drive route (e.g., regardless of separation of the tractor from the trailer and absence of shore power or grid power supplied to the trailer).

### 20. Fleet Management: Customer Profiles

In one implementation, the computer system can: monitor drive route data corresponding to a particular user over a period of time (e.g., six months, one year); detect a frequency of occurrence of a cluster of drive routes; and link the cluster of drive routes to the user in a user profile and store the user profile in a user profile database for future drive routes.

In one variation, the computer system can: monitor drive route data for a fleet of tractor-trailers associated with a particular user over a period of time (e.g., six months, one year); identify a cluster of drive routes during this period of time; track this cluster of drive routes during a next period of time (e.g., three months); calculate a frequency of occurrence of the cluster of drive routes; and, in response to the frequency of occurrence exceeding a threshold frequency, generate a timeseries of state of charge values of the battery assembly for each drive route in the cluster of drive routes, to ensure that a state of charge of a battery assembly of a future trailer meets the reserve state of charge at the destination location. The computer system can then link the nominal timeseries of state of charge values with each drive route and a particular user within a user profile and store the user profile in a user profile database. The computer system can implement methods and techniques described above for each other user and for each other tractor-trailer in a fleet of tractor-trailers in order to compile timeseries of state of charge values for each drive route into a user profile database for future drive routes.

For example, the local controller can: segment the drive route into a set of legs between the current location and the destination location; select a stored drive route from a historical drive route database; and, in response to a leg of the stored drive route corresponding to a current leg in the set of legs of the drive route, detect a stored state of charge of the battery assembly for a subsequent leg from the stored drive route. The local controller can then detect an exit state of charge of the battery assembly while the refrigerated trailer exits the current leg; and, in response to the exit state of charge of the battery assembly falling below the stored state of charge of the battery assembly for the subsequent leg, trigger the motor of the refrigerated trailer to output regenerative braking torque to the driven axle to recharge the battery assembly and to reduce a difference between the exit state of charge and the stored state of charge. Thus, the local controller can access a stored state of charge of the battery assembly from a previous drive route similar to a current drive route in order to refine current state of charge values and achieve the reserve state of charge of the battery assembly at the destination location.

Therefore, the computer system can track drive route data over a period of time to derive a timeseries of state of charge values for each drive route associated with a particular user and link these timeseries of state of charge values with each drive route and the particular user within a user profile. Additionally, the computer system can retrieve the timeseries of state of charge values from a user profile database for a next drive route to further increase the energy efficiency of the trailer during the next drive route.

### 21. Drive Route Segmentation+Target Zones

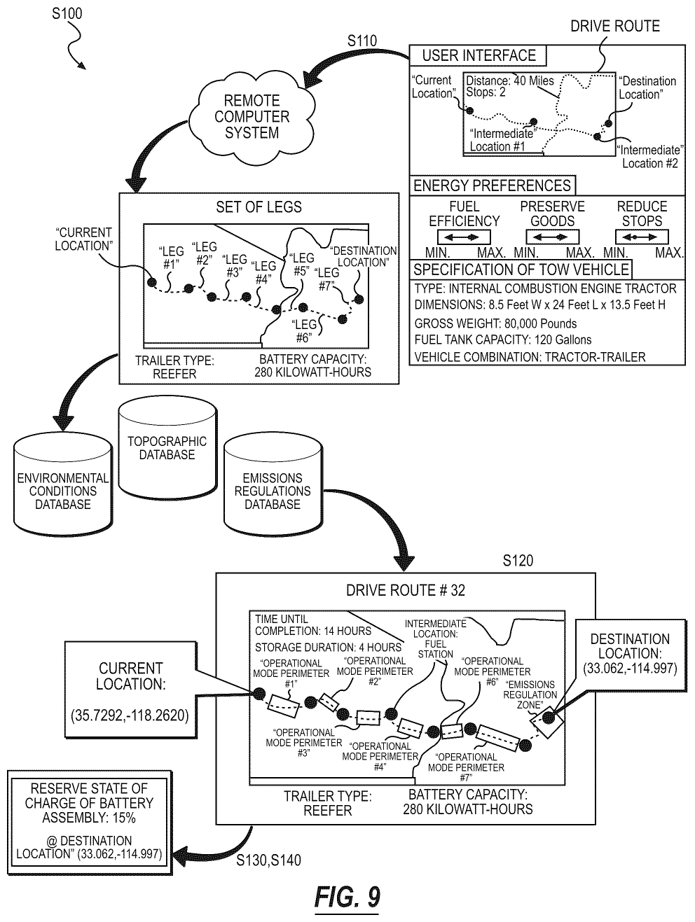

Generally, the computer system can receive the drive route including the start location and the destination location for a tractor-trailer and segment the drive route into a set of legs between the start location and the destination location (e.g., a one-mile leg or a 50-mile leg), as shown in FIG. 9.

In one implementation, the computer system can: segment the drive route into a set of legs between the start location and the destination location; access a set of databases to select topographical data, environmental condition data, speed limit data, and regulatory requirements (e.g., emissions or noise regulations) data corresponding to locations proximal each leg in the set of legs; and define a nominal environmental condition based on a combination of a set of environmental conditions. Then, based on the nominal environmental condition and the data from the databases, the computer system can: define a set of target zones corresponding to an operational mode of the trailer; assign each target zone to a leg between the start location and the destination location; and estimate a completion duration for the tractor-trailer to traverse the drive route. The computer system can then: update the drive route with the set of legs, annotated with the set of target zones, and the completion duration; and transmit the updated drive route to the local controller for execution by the tractor-trailer.

In one variation, the computer system can: access a set of satellite images and a map defined by the user depicting a particular region between the start location and the destination location; define a set of legs between the start location and the destination location defining navigation of a tractor-trailer; calculate a total distance between the start location and the destination location; define a trailer type and a battery capacity for the battery assembly of the trailer based on the total distance, the vehicle combination, and/or the gross weight of the vehicle combination; define a time interval for commencement and termination of the drive route; and estimate a completion duration of the drive route.

Furthermore, the computer system can access a set of conditions from additional databases, such as a topographical database, a speed limit database, and/or an emissions regulation database and access a set of satellite images depicting a geographic region between the start location and the destination location. The computer system can then define a set of target zones proximal the drive route corresponding to a torque output assist mode for the motor of the trailer to output torque to the driven axle and define a battery recharging mode for the motor to regeneratively brake the driven axle and charge the battery assembly of the trailer according to the set of conditions. The computer system can autonomously prioritize torque output assist by the motor to the driven axle, prioritize regenerative braking to charge the battery assembly, or disable torque output to reduce power consumption by the trailer according to each target zone.

For example, the computer system can define a set of legs representing locations between the start location and the destination location. Then, for each leg in the set of legs the computer system can: access a set of environmental conditions, such as wind speed, rainfall, humidity, and air temperature from a weather database for the location of the leg during a time period; calculate an average of each environmental condition in the set of environmental conditions during this time period; and define a nominal environmental condition for the location of the leg—such as rainfall of 10%, humidity of 24%, wind of 5 mph, and visibility of 10 miles—based on the average of each environmental condition. Then, the computer system can: access an elevation profile from a topographical database for this leg; access a set of regulatory requirements data corresponding to the location of this leg; and, based on the nominal environmental condition, the elevation profile, and the emissions regulation data, define a polygonal perimeter indicating a battery recharging mode for the trailer, such as a regenerative braking mode, a drag charging mode; and assign the polygonal perimeter to the leg.

The computer system can repeat these methods and techniques for each other leg in the set of legs and aggregate the location and the polygonal perimeter indicating the operational mode for each leg in the set of legs to generate an updated drive route. After updating the drive route, the computer system can present the drive route within the user interface and transmit the drive route to the local controller for execution.

### 21.1 Intermediate Locations: Charge Stations+Fuel Stations

In one implementation, the computer system can detect the total distance between the start location and the destination location and, responsive to the total distance exceeding the maximum distance range associated with a battery capacity of the trailer, access the tow vehicle type, indicating an internal combustion engine tow vehicle with a fuel tank or a diesel generator coupled to a refrigeration system of a refrigerated trailer, entered by the user via the user interface. The computer system can access a set of fuel station locations proximal the drive route from a fuel station database and assign a fuel station to a leg of the drive route to refill the fuel tank of the tow vehicle. Thus, the computer system can assign fuel station locations to legs of the drive route for internal combustion engine tow vehicle types in order to increase the maximum distance range of the tractor-trailer to the total distance of the drive route.

In another implementation, the computer system can detect the total distance between the start location and the destination location and, responsive to the total distance exceeding a maximum distance range associated with a battery capacity of the trailer, access the tow vehicle type, indicating an electric tow vehicle with a battery module, entered by the user via the user interface. The computer system can then access a set of charge station locations proximal the drive route from a charge station location database and assign a charge station location to a leg of the drive route to charge the battery assembly of the trailer and the battery module of the tow vehicle. Thus, the computer system can assign charge station locations to legs of the drive route for electric tow vehicle types to increase the maximum distance range of the tractor-trailer to the total distance of the drive route.

21.2 in-Process Drive Route Feedback

In one implementation, during the setup period, the computer system can access a set of conditions from additional databases, such as a topographical database, a speed limit database, and/or an emissions regulation database and access a set of satellite images depicting a geographic region between the start location and the destination location. The computer system can then manipulate this set of conditions to define a set of target zones proximal the drive route assigned to an operational mode, such as a torque output assist mode to prioritize torque output by the motor to the driven axle or a battery recharging mode to prioritize regenerative braking to charge the battery assembly of the trailer. During traversal of the drive route, the local controller can access geospatial location data, speed data, fuel consumption data, and state of charge of the battery assembly data via sensors coupled to the trailer chassis and autonomously prioritize torque output assist by the motor to the driven axle, prioritize regenerative braking to charge the battery assembly, or disable torque output to reduce power consumption by the trailer according to each target zone.

In one variation, during traversal of the drive route, the local controller can: detect a location of the trailer; and, in response to the location of the trailer falling within a target zone associated with a battery recharging mode, automatically prioritize regenerative braking by triggering the motor of the trailer to supply electrical energy to the battery assembly to regeneratively brake the driven axle and charge the battery assembly of the trailer.

In another variation, during traversal of the drive route, the local controller can: detect a location of the trailer; and, in response to the location of the trailer falling within a target zone associated with a torque output assist mode, automatically prioritize torque output assist by the motor to the driven axle.

### 21.3 Geospatial Location Feedback+Torque Output

In one variation, during traversal of the drive route, the local controller can: detect a location of the trailer; and, in response to the location falling within an operational mode perimeter associated with a torque output assist mode, automatically prioritize torque output assist by selectively triggering the battery assembly to supply electrical energy to the motor to increase and/or reduce torque output to the driven axle in the torque output assist mode.

For example, during traversal of the drive route, the local controller can access signals output by an IMU sensor coupled to the trailer chassis representing geospatial location data of the trailer and detect (35.011357, −118.927299) as a location of the trailer based on a signal from the IMU sensor. The local controller can extract a first vertex (34.921741, −118.927299) and a second vertex (35.488407, −118.927299) from a torque output assist mode perimeter of the drive route; and, in response to the location of the trailer (35.011357, −118.927299) falling within the first vertex (34.921741, −118.927299) and the second vertex (35.488407, −118.927299), prioritize torque output assist by selectively triggering the battery assembly to supply electrical energy to the motor to output torque to the driven axle.

Therefore, the local controller can autonomously prioritize torque output assist by selectively triggering the motor to output torque to the driven axle to preserve the state of charge of the battery assembly of the trailer and achieve the reserve state of charge of the battery assembly of the trailer upon termination of the drive route.

### 21.4 Geospatial Location and Speed Feedback+Battery Recharging

In one variation, during traversal of the drive route, the local controller can: detect a location of the trailer; and, in response to the location falling within an operational mode perimeter associated with battery recharging, prioritize regenerative braking to charge the battery assembly of the trailer. Alternatively, the local controller can: detect a location of the trailer; detect a speed of the trailer; and, in response to the location falling outside of an operational mode perimeter and, in response to the speed exceeding a threshold speed, disable torque output by the motor to reduce power consumption by the trailer.

For example, the local controller can access signals output by an IMU sensor coupled to the trailer chassis representing geospatial location data of the trailer. At a first time, the local controller can detect a first location of (35.011357, −118.927299) for the trailer based on a first signal from the IMU sensor. The local controller can extract a first vertex (34.921741, −118.927299) and a second vertex (35.488407, −118.927299) from a battery recharging perimeter of the drive route; and, in response to the location of the trailer (35.011357, −118.927299) falling within the first vertex (34.921741, −118.927299) and the second vertex (35.488407, −118.927299), prioritize regenerative braking to charge the battery assembly of the trailer. At a second time, the local controller can detect a second location of (35.5126, −118.927299) for the trailer and a speed of the trailer based on a second signal from the IMU sensor. In response to the second location of (35.5126, −118.927299) for the trailer falling outside of the battery recharging perimeter and, in response to the speed exceeding a threshold speed, the local controller can disable torque output by the motor to reduce power consumption by the trailer.

Therefore, the local controller can autonomously prioritize regenerative braking to charge the battery assembly of the trailer, and/or disable torque output by the motor to reduce power consumption by the trailer. Additionally, the local controller can selectively adjust the operational mode to preserve the state of charge of the battery assembly of the trailer and achieve the reserve state of charge of the battery assembly of the trailer upon termination of the drive route.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media, such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for monitoring energy of a refrigerated trailer comprising:
accessing a drive route for the refrigerated trailer between a current location and a destination location;
accessing a target temperature range for an interior of the refrigerated trailer containing a set of goods;
predicting a time duration between arrival of the refrigerated trailer at the destination location and unloading of the set of goods;
estimating a quantity of electrical energy to maintain temperatures of the interior of the refrigerated trailer within the target temperature range for the time duration;
calculating a target state of charge of a battery assembly of the refrigerated trailer to supply the quantity of electrical energy to a refrigeration system to modulate temperatures of the interior of the refrigerated trailer; and
during traversal of the drive route by the refrigerated trailer coupled to a tow vehicle:
selectively outputting torque to the driven axle to increase fuel efficiency of the tow vehicle; and
selectively regeneratively braking the driven axle to recharge the battery assembly and to achieve the target state of charge of the battery assembly upon arrival of the refrigerated trailer at the destination location.

2. The method of claim 1:
further comprising:
calculating a total distance of the drive route between the start location and the destination location;
accessing a battery capacity of the battery assembly of the refrigerated trailer; and
during traversal of the drive route by the refrigerated trailer:
estimating an energy consumption rate of the refrigerated trailer; and
predicting a distance traversable by the refrigerated trailer based on the battery capacity and the energy consumption of the refrigerated trailer; and
wherein selectively regeneratively braking to the driven axle comprises, in response to the distance traversable by the refrigerated trailer falling below the total distance of the drive route, triggering the motor to regeneratively brake the driven axle:
to recharge the battery assembly; and
to drive the battery assembly to a state of charge greater than the target state of charge.

3. The method of claim 1:
further comprising:
identifying an emissions regulation zone intersecting the drive route;
accessing an emissions threshold for the tow vehicle, hauling the trailer, within the emissions regulation zone;
estimating a total energy to traverse a leg of the drive route within the emissions regulation zone;
calculating a maximum energy from liquid fuel, available to the tow vehicle within the emissions regulation zone, based on the emissions threshold; and
calculating a minimum electrical energy stored in the battery assembly, upon entering the emissions regulation zone, based on a difference between the total energy and the maximum energy from liquid fuel; and
wherein selectively outputting torque to the driven axle comprises:
detecting a current location of the refrigerated trailer; and
in response to the current location intersecting the emissions regulation zone, triggering the battery assembly to supply the minimum electrical energy to a motor to output torque to the driven axle and to comply with the emissions threshold during traversal of the emissions regulation zone.

4. The method of claim 1:
further comprising:
identifying an emissions regulation zone intersecting the drive route;
accessing a threshold emissions limit for the refrigeration system of the refrigerated trailer within the emissions regulation zone;
estimating a total energy required to operate the refrigeration system of the refrigerated trailer during the leg of the drive route within the emissions regulation zone;
calculating a maximum energy from liquid fuel, available to a diesel-powered subsystem, within the refrigeration system, within the emissions regulation zone, based on the emissions threshold; and
calculating a minimum electrical energy, stored in the battery assembly, to supply to an electrical refrigeration subsystem, within the refrigeration system, upon entering the emissions regulation zone based on a difference between the total energy and the maximum energy from liquid fuel; and
further comprising, during traversal of the emissions regulation zone by the refrigerated trailer:
detecting a current location of the refrigerated trailer; and
in response to the current location intersecting the emissions regulation zone, triggering the battery assembly to supply the minimum electrical energy to the electrical refrigeration subsystem to comply with the emissions threshold during traversal of the emissions regulation zone.

5. The method of claim 1:
further comprising, during traversal of the drive route by the refrigerated trailer:
detecting a first location of the refrigerated trailer and a fuel consumption rate of the refrigerated trailer;
calculating a remaining distance of the drive route between the first location of the refrigerated trailer and the destination location;
detecting a fuel level in a fuel tank coupled to a diesel-powered refrigeration subsystem within the refrigeration system of the refrigerated trailer; and
predicting a distance traversable by the refrigerated trailer based on the fuel level and the fuel consumption rate; and
wherein selectively outputting torque to the driven axle to increase fuel efficiency of the tow vehicle comprises, in response to the distance exceeding the remaining distance of the drive route, triggering the battery assembly to supply electrical energy to the driven axle for the remaining distance of the drive route to increase fuel efficiency of the tow vehicle.

6. The method of claim 1:
further comprising, at the refrigerated trailer during traversal of the drive route:
segmenting the drive route into a set of legs between the current location and the destination location;
selecting a stored drive route from a historical drive route database;
in response to a leg of the stored drive route corresponding to a current leg in the set of legs of the drive route, detecting a state of charge of the battery assembly for a subsequent leg from the stored drive route; and
detecting an exit state of charge of the battery assembly while the refrigerated trailer exits the current leg; and
wherein selectively regeneratively braking to the drive axle comprises, in response to the exit state of charge of the battery assembly falling below the state of charge of the battery assembly for the subsequent leg, triggering a motor of the refrigerated trailer to output regenerative braking torque to the driven axle to recharge the battery assembly and to reduce a difference between the exit state of charge and the state of charge.

7. The method of claim 1, further comprising, during traversal of the drive route by the refrigerated trailer:
detecting a first state of charge of the battery assembly along the first leg; and
in response to the first state of charge exceeding the target state of charge of the battery assembly:
calculating an excess electrical energy stored in the battery assembly based on a difference between the first state of charge and the target state of charge of the battery assembly; and
allocating the excess electrical energy stored in the battery assembly for torque output by the refrigerated trailer to a second leg, in the set of legs, characterized by a positive slope.

8. The method of claim 7, wherein allocating the excess electrical energy stored in the battery assembly for torque output by the refrigerated trailer comprises:
accessing a first elevation profile of the second leg, in the set of legs, from a map database; and
in response to the first elevation profile indicating an altitude increase across the second leg, allocating the excess electrical energy stored in the battery assembly for torque output, by the refrigerated trailer, to the second leg in the set of legs along the drive route.

9. The method of claim 1:
further comprising:
predicting a second time duration for the refrigerated trailer to traverse the drive route; and
estimating a quantity of energy from liquid fuel to supply to a diesel-powered refrigeration subsystem within the refrigeration system to maintain temperatures of the interior of the refrigerated trailer within the target temperature range for the second time duration; and
wherein calculating the target state of charge of the battery assembly of the refrigerated trailer comprises calculating the target state of charge of the battery assembly of the refrigerated trailer to supply the quantity of electrical energy to an electrical refrigeration subsystem to modulate temperatures of the interior of the refrigerated trailer; and
further comprising, during traversal of the drive route, triggering the diesel-powered refrigeration subsystem to supply the quantity of energy to the refrigeration system to modulate temperatures of the interior of the refrigerated trailer.

10. The method of claim 1:
wherein accessing the drive route for the refrigerated trailer comprises accessing the drive route for the refrigerated trailer, the drive route specifying:
an intermediate location between the current location and the destination location; and
a storage duration for the set of goods contained in the refrigerated trailer at the intermediate location;
further comprising, in response to identifying absence of shore power at the intermediate location on the drive route:
estimating a second quantity of electrical energy to supply to an electrical refrigeration subsystem within the refrigeration system to maintain temperatures of the interior of the refrigerated trailer within the target temperature range for the storage duration; and
calculating a second target state of charge of the battery assembly, greater than the first state of charge, to supply the second quantity of electrical energy to the electrical refrigeration subsystem to modulate temperatures of the interior of the refrigerated trailer; and
wherein selectively regeneratively braking the driven axle comprises selectively regeneratively braking the driven axle:
to recharge the battery assembly; and
to achieve the second target state of charge of the battery assembly upon arrival of the refrigerated trailer at the intermediate location.

11. The method of claim 1, further comprising, in response to identifying presence of shore power at an intermediate location of the drive route:
decreasing the target state of charge of the battery assembly to supply the quantity of electrical energy to the refrigeration system to modulate temperatures of the interior of the refrigerated trailer at the destination location;
generating a prompt for a user to manually connect shore power at the intermediate location to an electrical port arranged on the refrigerated trailer; and
assigning the prompt to the intermediate location within the drive route; and
presenting the drive route to the user within the user interface.

12. The method of claim 1:
wherein accessing the target temperature range for the interior of the refrigerated trailer comprises receiving a cargo specification for the refrigerated trailer from a user via a user interface, the cargo specification defining:
a delivery window for unloading the set of goods;
a quantity of the set of goods contained within the interior of the refrigerated trailer; and
the target temperature range for the interior of the refrigerated trailer; and
wherein predicting the time duration between arrival of the refrigerated trailer at the destination location and unloading of the set of goods comprises predicting the time duration between arrival of the refrigerated trailer at the destination location and unloading of the set of goods:
based on the quantity of the set of goods; and
based on the delivery window for unloading the set of goods.

13. The method of claim 12:
further comprising, based on historical weather conditions for the destination location within time windows analogous to the delivery time window:
predicting an ambient temperature of air forecast within the delivery time window for the destination location; and
predicting an ambient humidity of air forecast within the delivery time window for the destination location; and
wherein estimating the quantity of electrical energy to maintain temperatures of the interior of the refrigerated trailer within the target temperature range comprises calculating the quantity of electrical energy to maintain temperatures of the interior of the refrigerated trailer within the target temperature range for the target duration:
inversely proportional to the ambient temperature of air forecast; and
inversely proportional to the ambient humidity of air forecast.

14. The method of claim 1:
further comprising:
rendering a first slider, in a set of sliders, in a user interface representing a first energy preference in a set of energy preferences, the first energy preference comprising fuel efficiency of the tow vehicle; and
interpreting the first energy preference as maximum fuel efficiency based on a first change in a position of the first slider bar; and
wherein selectively outputting torque to the driven axle comprises prioritizing torque output assist at the refrigerated trailer by triggering the battery assembly to supply electrical energy to the motor to output torque to the driven axle and to increase fuel efficiency of the tow vehicle according to the first energy preference.

15. A method for monitoring energy of a refrigerated trailer comprising:
accessing a drive route for a refrigerated trailer between a current location and a destination location;
receiving a set of energy preferences for the drive route from a user via a user interface;
accessing a target temperature range for an interior of the refrigerated trailer containing a set of goods;
predicting a time duration between arrival of the refrigerated trailer at the destination location and unloading of the set of goods;
estimating a quantity of electrical energy to maintain temperatures of the interior of the refrigerated trailer within the target temperature range for the time duration;
calculating a target state of charge of a battery assembly of the refrigerated trailer, coupled to the refrigerated trailer, to supply the quantity of electrical energy to modulate temperatures of the interior of the refrigerated trailer; and
during traversal of the drive route by the refrigerated trailer coupled to a tow vehicle:
selectively outputting torque to a driven axle of the refrigerated trailer to achieve the set of energy preferences; and
selectively regeneratively braking the driven axle to achieve the target state of charge of the battery assembly upon arrival of the refrigerated trailer at the destination location.

16. The method of claim 15:
wherein receiving the set of energy preferences comprises receiving selection of a first energy preference in the set of energy preferences from a user interface, the first energy preference comprising fuel efficiency of the tow vehicle; and
wherein selectively outputting torque to the driven axle comprises prioritizing torque output assist at the refrigerated trailer by triggering the battery assembly to supply electrical energy to the motor to output torque to the driven axle and to increase fuel efficiency of the refrigerated trailer according to the first energy preference.

17. The method of claim 15:
further comprising:
rendering a slider, in a set of sliders, in a user interface representing a first energy preference in a set of energy preferences, the first energy preference comprising preservation of the set of goods; and
in response to a change in a position of the first slider in the set of sliders, interpreting the first energy preference as preservation of the set of goods for the time duration; and
wherein selectively regeneratively braking the driven axle comprises triggering a motor to regeneratively brake the driven axle to recharge the battery assembly and to achieve the target state of charge of the battery assembly upon arrival of the refrigerated trailer at the destination location according to the first energy preference.

18. The method of claim 15:
wherein selectively outputting torque to the driven axle comprises, in a torque output assist mode, triggering the battery assembly to supply electrical energy to a motor of the refrigerated trailer to output torque to the driven axle and to achieve the set of energy preferences; and
wherein selectively regeneratively braking the driven axle comprises, in a regenerative braking mode, triggering the motor to supply electrical energy to the battery assembly to regeneratively brake the driven axle and charge the battery assembly.

19. A method for monitoring energy of a refrigerated trailer comprises:
accessing a drive route for the refrigerated trailer between a current location and a destination location;
identifying an emissions regulation zone intersecting the drive route;
accessing an emissions threshold for a tow vehicle, hauling the refrigerated trailer, within the emissions regulation zone;
estimating a total energy to traverse a leg of the drive route within the emissions regulation zone;
calculating a maximum energy from liquid fuel, available to the tow vehicle within the emissions regulation zone, based on the emissions threshold;
calculating a minimum electrical energy stored in a battery assembly of the refrigerated trailer, upon entering the emissions regulation zone, based on a difference between the total energy and the maximum energy from liquid fuel; and
allocating the minimum quantity of energy, stored in the battery assembly, to torque output by a motor of the refrigerated trailer:
to assist the tow vehicle while traversing the emissions regulation zone; and
to maintain emissions by the tow vehicle below the emissions threshold while traversing the emissions regulation zone.

20. The method of claim 19, further comprising:
accessing a specification for the refrigerated trailer defining a storage duration between arrival of the refrigerated trailer at the destination location and unloading of a set of goods contained in an interior of the refrigerated trailer;
calculating a target state of charge of a battery assembly of the refrigerated trailer to supply electrical energy to a refrigeration system to modulate temperatures of the interior of the refrigerated trailer for the storage duration; and
during traversal of the drive route by the refrigerated trailer:
selectively triggering a motor of the refrigerated trailer to output torque to the driven axle to increase fuel efficiency of the tow vehicle; and
selectively triggering the motor to regeneratively brake the driven axle to achieve the target state of charge of the battery assembly upon arrival of the refrigerated trailer at the destination location.
